(19) United States
(12) Patent Application Publication
(10) Pub. No.: US 2024/0178772 A1
(43) Pub. Date: May 30, 2024

(54) DC MOTOR COMPRISING ACCELERATOR AND ENERGY STORAGE RING

(71) Applicants: Zhenya ZHANG, Shanghai (CN); Jiaqing ZHANG, Shanghai (CN)

(72) Inventors: Zhenya ZHANG, Shanghai (CN); Jiaqing ZHANG, Shanghai (CN)

(73) Assignees: Zhenya ZHANG, Shanghai (CN); Jiaqing ZHANG, Shanghai (CN)

(21) Appl. No.: 18/277,082

(22) PCT Filed: Jul. 4, 2022
(86) PCT No.: PCT/CN2022/103684

§ 371 Date: Aug. 14, 2023

(30) Foreign Application Priority Data
Aug. 20, 2021 (CN) 202110959668.9

(51) Int. Cl. H02P 6/08; H02K 3/28; H02P 6/182; H02P 6/22

(52) U.S. Cl. CPC H02P 6/08; H02K 3/28; H02P 6/182; H02P 6/22

(57) ABSTRACT

A direct-current (DC) motor including an accelerator and an energy storage ring is disclosed, a rotor of the DC motor includes Z slots embedded with Z rotor hollow tubes (1), two ends of the Z rotor hollow tubes (1) are connected to rotor commutation rings (2), two fixed commutation rings (3) are installed on two sides of the two rotor commutation rings (2), a gap is provided between a fixed commutation ring (3) and a rotor commutation ring (2) adjacent to the fixed commutation ring (3), the two fixed commutation rings (3) communicates with each other through Z fixed hollow tubes (4), the Z rotor hollow tubes (1) and the Z fixed hollow tubes (4) constitute the energy storage ring (6), fixed commutation hollow tube groups (5) are connected at a junction of two main magnetic poles.

### TECHNICAL FIELD

The present disclosure relates to the field of accelerators and energy storage devices, and particularly relates to a direct-current (DC) motor including an accelerator and an energy storage device.

### BACKGROUND

At present, electric energy cannot be stored in large quantities, nor can it be carried in large quantities and conveniently. Furthermore, the cost of energy storage is also very high, and the weight to energy ratio is too high.

### SUMMARY

1. Technical Effects of the Present Disclosure: under the action of external power, charged gaseous particles in rotor hollow tubes of a new DC motor can be accelerated to store energy through the transformation and transmission of Lorentz force, so the new DC motor can be used as a DC generator to store energy, or a DC motor with an energy storage device storing a large amount of electric energy (electric energy stored in the charged gaseous particles in the rotor hollow tubes of the new DC motor can be converted into mechanical energy). When the speed of the charged gaseous particles reaches a relatively high speed, the new DC motor can store a large amount of energy. For example, when the speed of the charged gaseous particles in the rotor hollow tubes is increased to 10,000 kilometers per second, the amount of energy that can be stored in one gram of the charged gaseous particles is given by:

W=(1÷2) mV²=(1÷2)=1×10³×(10⁴×10³)²=5×10¹⁰ J.

The calorific value W′ of gasoline per kilogram is 4.6×10⁷ J/Kg, i.e., W′=4.6×10⁷ J/Kg.

W÷W′=(5×10¹⁰)÷(4.6×10⁷)=1.08×10³ Kg, in other words, the speed of the charged gaseous particles in the rotor hollow tubes is accelerated to 10,000 kilometers per second, the amount of energy that can be stored in the charged gaseous particles per gram is equivalent to that of energy stored by 1.08×10³ kilograms of gasoline, and the efficiency of converting electric energy stored by the charged gaseous particles into mechanical energy is much higher than that of converting the energy released by burning gasoline into mechanical energy; moreover, electric energy is environmentally friendly.

It can be seen that by accelerating the speed of the charged gaseous particles with very little mass to a certain high speed, a large amount of electric energy can be stored in the charged gaseous particles, and the mass of the charged gaseous particles themselves is very small.

### 2. Accelerator and Energy Storage Ring of New DC Motor

### 1) Overall Structure of New DC Motor Including Accelerator and Energy Storage Ring

A rotor of the DC motor includes Z slots embedded with Z rotor hollow tubes 1, wherein Z is an integer. A first end of the Z rotor hollow tubes 1 is connected to a first rotor commutation ring, and a second end of the Z rotor hollow tubes 1 is connected to a second rotor commutation ring. The Z rotor hollow tubes, the first rotor commutation ring, and the second rotor commutation ring constitute a rotor hollow tube winding. A first fixed commutation ring is installed on a first side of the first rotor commutation ring away from the Z rotor hollow tubes 1, and a second fixed commutation ring is installed on a second side of the second rotor commutation ring away from the Z rotor hollow tubes 1, wherein a gap is provided between the first fixed commutation ring and the first rotor commutation ring, and a gap is provided between the second fixed commutation ring and the second rotor commutation ring. The first fixed commutation ring communicates with the second fixed commutation ring through Z fixed hollow tubes 1. The Z rotor hollow tubes 1 and the Z fixed hollow tubes 4 constitute the energy storage ring 6. Fixed commutation hollow tube groups 5 are connected at a junction of two main magnetic poles (as shown in FIG. 1). The first rotor commutation ring and the second rotor commutation ring are rotor commutation rings 2, the first fixed commutation ring and the second fixed commutation ring are fixed commutation rings 3. The hollow tubes of the energy storage ring 6 include the Z rotor hollow tubes 1 and the Z fixed hollow tubes 4. The rotor hollow tubes 1 are made of non-magnetic materials. An inner or outer wall of the rotor hollow tubes is made of insulating materials to insulate it from an iron core. An inner or outer wall of the fixed hollow tubes 4 is also made of insulating materials to insulate the fixed hollow tubes from each other and from ground.

### 2) Structure of Hollow Tubes of DC Motor Including Accelerator and Energy Storage Ring

Each hollow tube in the energy storage ring includes a plurality of tiny thin-film cavities 8 made of ultra-thin materials, i.e., a thin-film partition layer 9 (e.g., ultra-thin glass with a thickness on the order of microns), wherein a width of an inner wall of each thin-film cavity 8 is in the order of micrometers, millimeters, or nanometers, and a height of the inner wall of each thin-film cavity 8 is in the order of millimeters, micrometers, or nanometers. A nano-scale conductive coating layer or a micron-scale conductive coating layer 10 (e.g., a chemical nickel coating layer) is continuously or intermittently plated on an inner wall of each hollow tube and the inner wall of each thin-film cavity 8 (i.e., positive and negative electrodes coexist). The thin-film cavities 8 are partially or entirely made of purely conductive materials (i.e., a pure conductive partition layer 11), so that electricity can be conducted between adjacent thin-film cavities 8 in the hollow tubes (as shown in FIG. 2). That is, there are multiple thin-film cavities 8 in each hollow tube, a gap between two adjacent thin-film cavities 8 is only on the micron or nanometer or millimeter scale, the inner wall of each thin-film cavity 8 is well conductive and are conductive to each other (or positive and negative electrodes coexist).

### 3) Commutation Structure of DC Motor Including Accelerator and Energy Storage Ring: The Commutation Structure Includes the Rotor Commutation Rings, the Fixed Commutation Rings, and the Fixed Commutation Hollow Tubes.

After the thin-film cavities 8 extend into the rotor commutation rings and the fixed commutation rings, a height of the thin-film cavities 8 remains unchanged, and a width of the thin-film cavities 8 gradually increases. The thin-film cavities 8 of equal height and width are evenly distributed at an end of the commutation rings (including the rotor commutation rings and the fixed commutation rings). As the thin-film cavities 8 extend closer to the end of the commutation rings, walls of the thin-film cavities 8 gradually thins, and as the thin-film cavities 8 reach the end of the commutation rings, the thickness of the walls of the thin-film cavities 8 is close to zero. The thin-film cavities 8 at the end of the commutation rings generate corona to discharge at a low voltage, so that high-speed moving neutral gas mediums close to the end of the commutation rings are positively charged and the neutral gas mediums are prevented from hitting the commutation rings due to coulomb repulsion (as shown in FIG. 3)

When high-speed moving rotor hollow tubes pass through the opposite magnetic poles, the direction of force on the charged particles in the rotor hollow tubes is opposite to its direction of motion. Therefore, before the charged particles changes its direction of motion, the charged particles are introduced into the fixed commutation hollow tubes, so that the charged particles and neutral gas moving at a high speed are introduced into another hollow tube whose direction of motion is the same as the direction of motion of the charged particles through the fixed commutation hollow tubes and then continue to be accelerated. An input end 7, which is for inputting the charged particles, of a fixed hollow tube corresponding to the rotor hollow tube whose charged particles have been exported, is closed without connecting a hollow tube, making the rotor hollow tube whose charged particles have been exported become an empty tube with zero charged particles. After entering the opposite magnetic pole, the rotor hollow tube whose charged particles have been exported receives charged particles moving in the opposite direction to the original charged particles, thus avoiding collision and continuing to accelerate.

Charged particles moving in the opposite direction to the original charged particles can be introduced into an empty rotor hollow tube through a fixed commutation hollow tube (as shown in FIG. 1). Or charged particles moving in the same direction to the original charged particles can be introduced into an empty rotor hollow tube through a fixed commutation hollow tube.

P pairs of magnetic poles correspond to 2P fixed commutation hollow tube groups. Each fixed commutation hollow tube group can include a single commutation hollow tube or multiple commutation hollow tubes.

The charged particles with the same polarity or the mixture of the charged particles with the same polarity and the neutral gas mediums (e.g., pure argon gas) are injected into each thin-film cavity of the hollow tubes of the energy storage ring, and the inner wall of each thin-film cavity in the hollow tubes has a DC voltage with the same polarity as the charged particles (or positive and negative electrodes coexist).

The structures of a stator and an iron core of the rotor of the new DC motor are basically the same as that of a stator and an iron core of the rotor of ordinary DC motors.

### 3. Analysis of Voltage of Charged Particles in Hollow Tubes and Division Size of Hollow Tubes in new DC Motor Including Accelerator and Energy Storage Ring

According to Gauss's law, the voltage of the charged particles in a thin-film cavity is given by:

u=Q_{R}÷(4πε₀r),
wherein u represents the voltage of the charged particles in the thin-film cavity,
Q_{R} represents a total amount of charges surrounded by the thin-film cavity with a sphere radius of r,
ε₀ represents the vacuum permittivity.

Assuming that the height of the inner wall of the thin-film cavity is hs, the width of the inner wall of the thin-film cavity is bs, and 2r=bs,
wherein r represents a minimum distance from a center of the thin-film cavity to an inner wall of the thin-film cavity.

Assuming that the charged particles is uniformly distributed in the thin-film cavity,

then u=Q_{R}÷(4πε₀r)=(4/3)πr³ρ÷(4ε₀r)=r²ρ÷(3ε₀),
wherein ρ represents the density of the charged particles in the thin-film cavity.

From the above formula, it can be seen that the voltage u of the charged particles in the thin-film cavity is proportional to the square of the sphere radius r and the density ρ of the charged particles. When the voltage u of the charged particles is constant, the density ρ of the charged particles is inversely proportional to the square of the sphere radius r.

An average induced electromotive force of a rotor conductor of the DC motor is given by: eₐᵥ=2pφn÷60.

Rotor hollow tubes of the new DC motor are connected in parallel, so u=eₐᵥ=Eₐ,
wherein eₐᵥ represents the average induced electromotive force of the rotor conductor (unit: V), Eₐ represents an electromotive force of an armature (unit: V), p represents the number of pairs of magnetic poles,
φ represents a magnetic flux per pole (unit: Wb), n represents the number of revolutions per minute of the armature.

When the magnetic flux is constant, the higher the voltage (i.e., the average induced electromotive force eₐᵥ) is, the faster the rotating speed is. Since the rotating speed is limited, the voltage cannot be too high, and the insulation cannot withstand the high voltage. If the voltage is not high and the size of the hollow tube is too large, the density of the charged particles in the hollow tubes will be very small, and the current of the rotor will be very small. If the current of the rotor is small and the voltage is low, the power of the DC motor will be very small.

If the hollow tubes are divided into many thin-film cavities with gaps using micrometer or nanometer level thin films, the voltage (i.e., the average induced electromotive force eₐᵥ) don't need to be too high in order for the density of the charged particles to meet the requirement, to sufficiently increase the current of the motor, thereby obtaining a larger power of the motor. For details, please refer to the following specific embodiments.

4. Effective Condition for Storing Energy of Charged Particles in Hollow Tubes, Effective Condition for Starting, and Improvement Measures in new DC Motor Including Accelerator and Energy Storage Ring

### 1) Effective Condition for Storing Energy of Charged Particles in Hollow Tubes in DC Motor Including Accelerator and Energy Storage Ring

According to the formula F=ma=evB (as shown in FIG. 4),

F=mv²÷R, mv²÷R=evB, R=mv÷(eB),

f=V÷(2πR)=eB÷(2πm),
wherein R represents a radius of a particle's motion path (unit: m),
m represents a mass of the particle (unit: kg),
V represents a speed of the particle (unit: m/s),
e represents a charge of the particle (unit: C),
B represents a magnetic flux density (unit: Wb/m²),
f represents a frequency (unit: cycles per second or circumferences per second).

When the charged particles move under the action of Lorentz force, they move in a circular manner and the circular path is shown in FIG. 4,
wherein α represents an acceleration; when the movement frequency of the charged particles is f, the time required for one cycle of motion is 1÷f.

If the rotor rotates at a high speed, the charged particles in the rotor hollow tube (No. 1) will be accelerated to store energy under the action of Lorentz force. At the same time, the gas particles in the rotor hollow tube (No. 1) and the corresponding fixed hollow tube (No. 1) are accelerated to store energy storage through collision. Because the charged particles fill the entire hollow tube, the charged particles are evenly distributed in the hollow tube due to Coulomb repulsion. When the charged particles in the rotor hollow tube (No. 1) accelerate and displace, the entire hollow tube (No. 1) has corresponding acceleration displacement to store energy due to Coulomb repulsion. However, the direction of the acceleration a of the charged particles in the rotor hollow tube (No. 1) can change significantly during the energy storage process. Assuming that the accelerated charged particles have moved ¼ of a cycle, then the acceleration a has made a 90 degree-change in direction. At this time, if the rotor hollow tube (No. 1) has not left the fixed hollow tube (No. 1), subsequent acceleration of the charged particles is ineffective. If the accelerated charged particles in the rotor hollow tube (No. 1) have moved half a cycle and the rotor hollow tube (No. 1) has not left the fixed hollow tube (No. 1), the accelerated charged particles will prevent energy storage and the energy storage effect will be very poor.

Therefore, the effective condition for storing energy is: when the rotor rotates at a high speed, the acceleration time Δt of the charged particles in a rotor hollow tube should be greater than the time Δt′ required for the rotor hollow tube to travel through the corresponding fixed hollow tube,

i.e., Δt=1÷(4f)>Δt′=b÷V,
wherein b represents a width along the rotor circumference,
V represents a circular speed of the rotor (unit: m/s),
b has three potential values, i.e., b1, b2, and b3, b1 is greater than twice the width of the thin-film cavities, in the nanometer or micrometer level; b2 is a pitch, about twice the width of the inner wall of the hollow tubes, in the millimeter or centimeter level; b3 is a polar distance.

According to the formula f=V÷(2πR)=eB÷(2πm) (cycles per second or circumferences per second),

If the charged particles are to be effectively accelerated, the following formula should be met:

1÷(4f)=πm(2eB)>b÷V.

If the change in the direction of the acceleration a is less than 30 degrees, that is, within 1÷(12f), and the rotor hollow tube moves for a time of Δt=b÷V,
1÷(12f)=πm÷(6eB)≥b÷V, wherein b=b3 (the polar distance).

In this case, the energy storage efficiency of the motor is very high.

In summary, if the charged particles in the rotor hollow tubes change the direction of their acceleration a by less than 30 degrees during the acceleration and the rotor hollow tubes have moved a polar distance, the energy storage efficiency of the motor will be very high.

That is, 1÷(12f)=πm÷(6eB)≥b÷V, wherein b=b3 and b is the polar distance.

The minimum effective condition for storing energy is given by: 1÷(4f)=πm÷(2eB)>b1÷v, wherein b1 is twice the width of the thin-film cavity.

### 2) Effective Condition for Starting Energy Storage in DC Motor

Only when the speed of the charged particles in a rotor hollow tube reaches a certain value, a high-speed moving rotor hollow tube can be transformed from a rotor hollow tube with the charged particles to an empty rotor hollow tube without charged particles when it passes through the opposite pole, so that oppositely moving charged particles can enter the empty rotor hollow tube without collision, avoiding energy loss, and difficulties in energy storage. However, because the initial speed of the charged particles is zero at startup, it will be difficult for a rotor hollow tube to become an empty rotor hollow tube without particles. Therefore, the following effective condition for starting energy storage must be met:

When the initial speed of the charged particles is zero, the distance Lₐ traveled by the charged particles is given by:

Lₐ≤0.5a(Δt)², Δt=b÷V, a=v²÷R,

R=mv÷(eB), 1÷(4f)=πm÷(2eB)≥b÷V,

Lₐ≤0.5a(Δt)²=0.5×(v²÷R)×(b÷V)²=b²÷(2R)=b²÷[2mv÷(eB)]=eBb²÷(2mv),

Lₐ≤eBb²÷(2mv), wherein V=Vₐ,

It can be seen that when the effective condition for starting energy storage is met, as the value of b increases linearly, Lₐ can increase by the square, and the larger the value of the speed V is, the smaller the value of Lₐ is. The mass m of the charged particles should meet a formula m≥b×2eB÷(πV)=m₀.

When the mass m of the charged particles is greater than m₀, the speed of the charged particles can be reduced to V₀ at startup.

When m=b×2eB÷(πV₀), that is, V₀=b×2eB÷(πm),

Lₐ≤eBb²=(2mv)=eBb²÷{2[b×2eB÷(πV₀)]V₀},

Lₐ≤(πb)÷4,

That is, under the premise of meeting the effective condition for starting energy storage, b should be as large as possible, since Lₐ≤(πb)÷4.

At startup, the speed of the motor is reduced to V₀ to make V₀=b×2eB÷(πM),

so that the effective condition for storing energy is met.

Lₐ represents the length of the rotor.

If b=τ=πDₐ÷(2p), wherein r represents the polar distance, and the polar distance is large when p=1.

### 3) Improvement Measures for Storing Energy Storage of DC Motor

According to the formula m≥b×2eB÷(πV), when the mass of the charged particles is very small, b is also very small and the length of the rotor cannot be very small, in which case, although the effective condition for storing energy is met, the effective condition for starting energy storage cannot be met. The improvement measures for starting energy storage are: large mass charged particles that meet the effective condition for starting energy storage are injected, that is, two types of charged particles are injected to start together, and small-mass charged particles are driven by large-mass charged particles that meet the effective condition for starting energy storage. When a certain speed is reached, that is, Lₐ=V_{d}Δt=V_{d}(b÷Vₐ) the small-mass charged particles are left in the energy storage ring and the large-mass charged particles are exported through magnetic confinement, thereby completing the startup of small-mass charged particles.

V_{d} represents the speed of the charged particles in the energy storage ring,

Vₐ represents a circular speed of the rotor.

### 5. Analysis of Function and Structure of Commutator in New DC Motor Including Accelerator and Energy Storage Ring

The commutator of the new DC motor is completely different from that of an ordinary DC motor. If there is no commutator, after the charged particles in the rotor hollow tube enter the thin-film cavities of the fixed hollow tubes at a high speed, the charged particles will collide with the walls of the hollow tubes and the walls of the thin-film cavities at the position between the inner walls of the adjacent fixed hollow tubes due to a high rotating speed of the rotor; after the charged particles enters a first end of the fixed hollow tubes, the charged particles will then enter the rotor hollow tubes from a second end of the fixed hollow tubes through the energy storage ring, at which time the charged particles will also collide with materials such as a rotor teeth of the iron core at positions between the inner walls of adjacent rotor hollow tubes. For this reason, the two ends of the rotor hollow tubes need to be equipped with a rotor commutation ring. Gaps are provided between the two rotor commutation rings and the two fixed commutation rings (a gap is provided between the first fixed commutation ring and the first rotor commutation ring, and a gap is provided between the second fixed commutation ring and the second rotor commutation ring). The function of the commutation rings of the commutator is to avoid the material on the position between the inner walls of the hollow tube being hit by the charged particles moving at a high speed. In addition, when the rotor hollow tubes rotate at a high speed, the direction of force on the charged particles in the rotor hollow tubes changes. Therefore, the fixed commutation hollow tubes are installed at the place where magnetic poles change. The charged particles in the rotor hollow tubes are introduced into a hollow tube of the charged particle with the same direction of motion as their charged particles through the fixed commutation hollow tubes, and continue to accelerate.

### 6. Analysis of Energy Storage Process, Energy Storage Method, and Motor Process for Energy Release in DC Motor Including Accelerator and Energy Storage Ring

### 1) Energy Storage Process

When external mechanical energy drives the rotor of the DC motor to rotate, the rotor hollow tubes of the rotor move at a speed V and the charged particles in each thin-film cavity in the rotor hollow tubes also move at a speed V Under the action of Lorentz force, the external power is transformed to accelerate the charged particles. As mentioned earlier, if the effective condition for storing energy is met, the charged particles in each thin-film cavity in each rotor hollow tube in an energy storage ring will be continued to accelerate and store energy.

The effective condition for storing energy is given by: 1÷(12f)=πm÷(6eB)≥b÷V, wherein b=b3 and b3 is the polar distance.

When the rotor hollow tubes are displaced by less than one pole distance, the change of the acceleration direction of the charged particles in the rotor hollow tubes is less than 30 degrees. That is, all the charged particles in the hollow tubes (called a group of hollow tubes) are always effectively accelerated within one polar distance. Each pair of magnetic poles forms two groups of hollow tubes with opposite directions of motion for their charged particles. At intersections between two groups of hollow tubes where directions of motion for the charged particles are opposite, fixed commutation hollow tubes are adopted. As previously mentioned, as long as the starting requirement is met, rotor hollow tubes having their charged particles exported can become empty tubes with no charged particles and neutral gas mediums to avoid collision between charged particles. Similarly, the thickness of an end of the commutation rings approaches zero, in which case corona is generated to discharge at a low voltage to avoid the neutral gas hitting the ends of the commutation rings.

### 2) Motor Process of Energy Storage Release

Each pair of magnetic poles forms two groups of hollow tubes with opposite directions of motion for their charged particles, which forms the DC motor.

3) Two Methods for Storing Energy: one is to only inject the charged particles into the energy storage ring, which can make the charged particles reach a high speed in a short time. However, the current for the rotor of the motor cannot be too large:

I=Q÷T, wherein Q represents the amount of charges (unit: C), T represents time (unit: s). because the speed of the charged particles is high and the circumference of the energy storage ring will not be very long, stored energy is also very small with the limited number of the charged particles. Another method for storing energy is to inject neutral gas mediums and the charged particles, after the charged particles collide with the neutral gas mediums continuously, the energy storage mass greatly increases, and then a large amount of energy storage is achieved without increasing the current of the rotor. Neutral gas includes inert gas (e.g., argon gas) or neutral gas molecules that do not easily produce charged particles through collision (e.g., SF6 gas).

### 7. Confinement and Stable Operation of High-Speed Charged Particles in Thin-Film Cavities in DC Motor Including Accelerator and Energy Storage Ring

After continuous acceleration and collision, the charged particles and neutral gas mediums in the thin-film cavities in the energy storage ring will continue to store energy. As the speed of the charged particles and the neutral gas mediums increases, the charged particles and the neutral gas mediums in thin-film cavities in the energy storage ring moves at a high speed. Because an air gap is provided between the stator and the rotor and air gaps are provided between the rotor commutation rings and the fixed commutation rings, it is necessary to confine and stabilize the high-speed moving charged particles in the hollow tubes.

As mentioned earlier, the inner wall of each thin-film cavity in each hollow tube has a DC voltage with the same polarity as the charged particles (or positive and negative electrodes coexist). This brings the following constraints to high-speed moving charged particles:
1) The inner walls of the hollow tubes and each thin-film cavity have the DC voltage with the same polarity as charged particles, so that the charged particles overcome their own weight and are suspended in each thin-film cavity;
2) The DC voltage on the inner wall of each thin-film cavity confines suspended charged particles, keeping them away from the inner walls of thin-film cavities and reducing a friction loss of high-speed moving charged particles on the inner walls of the thin-film cavities;
3) when the charged particles moves forward at a high speed, a local low vacuum is formed behind the charged particles to enable neutral gases to be confined behind the charged particles, and gas that is constrained by high-speed moving charged particles is formed, that is, as long as the charged particles are constrained, the neutral gas molecules are also constrained, and a negative pressure is also formed in an air gap between a rotor commutation ring and a corresponding fixed commutation ring to enable the inside of the motor to remain vacuum and prevent gases from leaking from the thin-film cavities.

The charged particles with the same polarity fill entire closed hollow tubes, when a charged particle in the rotor hollow tubes accelerates, other charged particles will also move due to synchronous repulsion, thereby accelerating the charged particles as a whole in the hollow tubes.

In summary, simply by applying to the inner walls of the thin-film cavities the DC voltage having the same polarity as the charged particles (or positive and negative electrodes coexist), can the high-speed moving charged particles and neutral gas molecules be well constrained in the thin-film cavities.

5) As mentioned earlier, corresponding parameters (e.g., the speed of the charged particles, the radius for the energy storage ring, and the flux density) are selected to meet the formula R=mV (eB), and high-speed moving charged particles stably operate in the closed energy storage ring using magnetic confinement.

In summary, high-speed charged particles can be stably constrained and transversely stabilized in each thin-film cavity by the DC voltage constraint and magnetic constraint.

8. in DC Motor Including Accelerator and Energy Storage Ring, Selection of Charged Particles in Each Thin-Film Cavity, Method For Injecting Charged Particles and Neutral Gas, and Methods for Introducing DC Voltage into Walls for Each Thin-Film Cavity

1) Selection of Charged Particles in Each Thin-Film Cavity: according to previous analysis, the mass of the charged particles needs to meet the effective condition for acceleration: 1÷(4f)=πm÷(2eB)>b÷V,

By selecting different values of b, different masses of the charged particles can be obtained. According to calculations from several specific examples below, the charged particles can be selected from nanomaterials and gas molecules of deuterium and tritium.

2) Method for Injecting Charged Particles and Neutral Gas into Each Thin-Film Cavity:

The charged particles and the neutral gas are injected under vacuum using high-frequency discharge ion sources or dual plasma ion sources. The method is: pumping the energy storage ring into a high vacuum, injecting the charged particles into the energy storage ring using an ion source under vacuum, and injecting neutral gases into the energy storage ring.

3) Inner Wall of Each Thin-Film Cavity Being Provided the DC Voltage With the Same Polarity as Charged Particles by: passing a wire carrying the DC voltage (or positive and negative electrodes coexist) through an insulating layer of the thin-film cavities to connect to the conductive coating layer (such as, a nickel plating layer) (or positive and negative electrodes coexist) of the hollow tubes, so that the inner wall of each thin-film cavity is provided the DC voltage (or positive and negative electrodes coexist) with the same polarity as the charged particles, introducing the thin-film cavities of the rotor by brushes and collector rings, and applying the DC voltage (or positive and negative electrodes coexist) when the rotor hollow tubes and the fixed hollow tubes pass through the insulating layer at equal distances.

### 9. Vacuum Sealing Method and Cooling Method for DC Motor Including Accelerator and Energy Storage Ring

### 1) Vacuum Sealing Method

Unnecessary space in the interior of the DC motor should be minimized. Except for the rotor, the stator, and the small gap between the rotor commutation rings and the stator commutation rings, the rest portions of the DC motor are sealed. The air pressure in the inside of the motor is pumped to 10⁻⁸ pa using a turbo molecular pump, and then the charged particles are injected under vacuum using an ion source, a rotating part of a shaft pump is sealed by magnetic fluid, which can make the air pressure of the rotating part of the shaft pump reach 10⁻⁷ pa.

### 2) Cooling Method

Because the charged particles in the rotor hollow tubes and the fixed hollow tubes forming the energy storage ring move at a high speed, the fixed hollow tubes are cooled, thereby cooling the entire energy storage ring and the iron core of the rotor.

### 10. External Mechanical Energy Method for DC Motor Including Accelerator and Energy Storage Ring

There are two methods of storing energy in the DC motor driven by a prime mover, a first method is to use a prime mover to drive the DC motor to store energy through mechanical methods, and a second method is to integrate an external DC motor and an energy storage DC motor together to form the DC motor including the accelerator and the energy storage ring, so that the external DC motor rotates at a high speed to drive the energy storage DC motor to store energy. There are two specific ways: a rotor armature (wires) of the DC motor (an external power supply) is placed on the rotor hollow tubes, or the hollow tubes are placed on the top of a commutator (an external power supply), which can reduce the diameter of the commutator. It is feasible to integrate the DC motor with the DC energy storage machine, because they are both DC motors, with similar structures, comparable power, volume and weight, and convenient energy storage, only a DC power supply is applied to the DC energy storage machine for energy storage. After energy storage, it can be used as a power source to release the stored power as a DC motor.

However, it should be noted that when the DC energy storage machine is used as the DC motor, an armature winding for the external prime mover's DC motor will generate induced electromotive force. A closed winding will generate large short-circuit current, so a controllable switch needs to be installed. When the DC energy storage machine is used as the DC motor, armature windings for the external prime mover's DC motor are disconnected.

### 11. Method for Regulating Speed of DC Motor Including Accelerator and Energy Storage Ring

A first method is to regulate the rotating speed of the accelerator and the energy storage ring using magnetic field weakening, wherein the rotating speed of the accelerator and the energy storage ring is regulated upward from a rated speed, which is similar to ordinary DC motors.

A second method is to regulate the rotating speed of the accelerator and the energy storage ring by reducing the voltage of the charged particles in the thin-film cavities of the rotor: indirectly reducing the voltage of the charged particles of the thin-film cavities of the rotor by reducing a voltage of an inner wall of the thin-film cavities of the rotor hollow tubes and a voltage of an inner wall of the thin-film cavities tubes of the fixed hollow tubes, wherein the lower the voltage of the charged particles is, the lower the rotating speed of the accelerator and the energy storage ring is, wherein the rotating speed of the accelerator and the energy storage ring is regulated downward from the rated speed.

A third method: the DC motor of the prime mover and the energy storage DC motor are integrated into the DC motor including the accelerator and the energy storage ring, when the DC energy storage machine is used as the DC motor, an armature winding of the DC motor of the external prime mover is closed for a short time; if a direction of a torque generated by the DC motor of the external prime mover is opposite to that of a torque generated by the DC energy storage machine, a rotating speed of the DC energy storage machine is decreased, and if a short-circuit current of a rotor of the external DC motor is too large, a resistor is connected in series with the rotor of the external DC motor.

The present disclosure can be applied to electric cars, electric airplanes, electric spacecrafts, energy storage equipment for solar energy and wind energy, peak shaving equipment for power grids, heavy ion accelerators or neutron sources, effective tools to make atomic fission power safer for power generation.

The present disclosure may be used as an important and effective tool and apparatus for realizing commercially controllable atomic energy fusion reactions for power generation.

### BRIEF DESCRIPTION OF THE DRAWINGS

FIG. 1 is a schematic structural diagram of an overall structure of a new DC motor including an accelerator and an energy storage ring.

FIG. 2 is a schematic diagram of dividing hollow tubes into tiny thin-film cavities.

FIG. 3 is a schematic structural diagram of a fixed commutation ring.

FIG. 4 shows a path of motion of positively charged particles in a magnetic field.

### REFERENCE NUMERALS

1 Rotor hollow tube
2 Rotor commutation ring
3 Fixed commutation ring
4 Fixed hollow tube
5 Fixed commutation hollow tube
6 Energy storage ring
7 Closed input end at a junction of the magnetic poles
8 Tiny thin-film cavity
9 Thin-film partition layer
10 Micron-level conductive coating layer
11 Pure conductive partition layer
12 Outer layer of a hollow tube
13 Wall of a hollow tube and an iron core
14 Wall of the fixed hollow tubes and a cooling partition for heat dissipation
15 Positive charge
16 Flux density (outward)

### DETAILED DESCRIPTION

### Application 1: Electric Vehicles

### 1) Selection of Main Parameters and Dimensions of Motor

P_{N}=200 kW, n_{N}=9000 rpm, B=1.8 Wb/m², wherein P_{N} represents the power of the motor, n_{N} represents a rotating speed of the motor, B represents a magnetic flux density,
P_{N}÷n_{N}=0.222; when Dₐ=25 cm, 2p=2, and Z=48, wherein P represents the number of poles, Z represents the number of slots,
τ=πDₐ (2p)=39.25 cm, wherein τ represents a polar distance; assuming that Lₐ=25 cm, wherein Lₐ represents the length of an armature,

when b=τ=39.25 cm, Lₐ°=30 cm based on a starting condition Lₐ°=(πb)÷4.

It can be seen that Lₐ=25 cm<Lₐ°=30 cm, which meets the starting condition.
Dj=Dₐ÷0.55=45.5 cm, and hs=24 mm, wherein Dj represents the outer diameter of a base, hs represents the height of an inner wall of the hollow tubes,
Vₐ=πDₐ×n=60=118 m/s, and ta=πDₐ÷Z=1.6 cm, wherein Vₐ represents a peripheral speed of the armature, ta represents a pitch,
bs=ta 2=8 mm, wherein bs represents the width of the inner wall of the hollow tubes,
an average induced electromotive force of a rotor conductor is given by:

eₐᵥ=2pφn÷60=2pBτ Ln=60=2×1.8×0.3925×0.25×9000÷60=53(v),
eₐᵥ=Eₐ, wherein Eₐ represents an electromotive force of the armature.

Assuming that the radius R of an energy storage ring is 0.4 m, and the circumference L of the energy storage ring is 6 m.

When the speed V of charged particles and neutral gases is accelerated to 600 km/s,

the frequency f of motion of the charged particles and the neutral gases in the energy storage ring is 10⁵ cycles per second, i.e., f=V÷L=600×10³, 6=10⁵ cycles per second.

### 2) Selection of Size, Structure and Material of Hollow Tubes

According to the above analysis, the size of the hollow tubes must be small enough to keep the voltage of the hollow tubes low and the density of the charged particles high.

The rotor hollow tubes are made of mica materials. Assuming that the thickness of the rotor hollow tubes is 1 mm, the height of an inner wall of the rotor hollow tubes is 24 mm, the width of the rotor hollow tubes is 6.85 mm, and the length of the rotor hollow tubes is equal to that of an iron core of the rotor (i.e., Lₐ=2500 mm). The inner wall of the hollow tubes is coated with a conductive nickel plating layer with a thickness of only 5 microns. The hollow tubes are divided by using ultra-thin glass (which is bendable) with a thickness of 30 microns. A top surface and a bottom surface of the ultra-thin glass are coated with a nickel plating layer (using chemical methods) with a thickness of only 5 microns. The total thickness of a thin film formed by the ultra-thin glass and two nickel plating layers is therefore 40 microns and a distance between the two adjacent thin films is also set to be 40 microns, that is, the rotor hollow tubes are divided along the length of the circumference of the rotor hollow tubes.
bs=8 mm, and along the width of the inner wall of the hollow tubes, the hollow tubes are separated every 40 microns; hs=24 mm, and along the height of the inner wall of the hollow tubes, the hollow tubes are separated every 1 mm,
a partition layer (i.e., a conductive nickel plating layer) of 40×40 μm² (which refers to the cross-sectional area of the partition material with a partition interval of 1 mm) is used.

### 3) Calculation of Density of Charged Particles, Current of Rotor, and Power of Motor

According to Gauss's law, a voltage of the enclosed cube (i.e., the voltage of the charged particles in each hollow tube) is given by:

u=Q_{R}÷(4πε₀r),
wherein u represents the electromotive force (i.e., the voltage) of the charged particles in the rotor hollow tubes, u=eₐᵥ=Eₐ;
eₐᵥ represents an electromotive force of the rotor hollow tubes, Eₐ represents the electromotive force of the armature,
when the volume of a cube is 40×40×40 μm³, r=40 2=20 μm,
Q_{R} represents a total amount of charges enclosed by the cube, u=eₐᵥ=53(v),

Q_{R}=4πε₀ru=Q_{R}=4πε₀r×u=4π×1÷(36π)×10⁹×20×10⁶×53=118×10⁻¹⁵C,
ρ₀=Q_{R}÷V°, wherein ρ₀ represents a density of the charged particles (unit: C/mm³)

V₄=40×40×40 μm³=(40×10³) mm³

ρ₀=Q_{R}÷V°=(118×10⁻¹⁵)÷(40×10³)=184×10⁻⁹C/mm³

Vₛ≈hs×(bs÷2)×L′×Z (considering that the volume of the thin films occupies half of the total volume of the hollow tubes), Vₛ≈24×(8÷2)×6×10³×48=27.6×10⁶ mm³, wherein Vₛ represents the volume of gases in the rotor hollow tube.

Q_{L}=Vₛ×ρ₀=27.6×10⁶×1.84×10⁹=5×10⁻², f=10⁵ cycles per second, wherein Q_{L} represents the amount of charges of the charged particles in the storage energy ring,
I=Q_{L}f=5×10⁻²×10⁻⁵=5×10³ A=5 kA, wherein I represents a current value of the rotor
A=I=πDₐ=5×10³÷(3.14×25)=63 A/cm, which meets the requirement, wherein A represents a linear charge of the motor.
W=I×u=5×53=265 kW, wherein W represents the power of the motor,
F=IBL=5×1.8×0.25=2.25 kN, M=F×Dₐ÷2, wherein M represents a torque,

M=2.25×10³×0.25÷2=281 N·m

### 4) Selection of Charged Particles and Neutral Gas Molecules

According to an effective condition for storing energy of the charged particles, the minimum requirement of the effective condition for storing energy is given by: 1÷(4f)=πm÷(2eB)>b1÷V,
wherein b1 is a width of the thin-film cavities.

A condition for high energy storage efficiency of the motor is given by:
1÷(12f)=πm÷(6eB)≥b÷V, wherein b=b3 and b3 represents is the polar distance.

b has two potential values, one is b=τ=πDₐ÷(2p), and the other is the micrometer-level division size in the hollow tubes. The differences brought about by the two values of b are below:
when b=τ=πDₐ÷(2p)=39.25 cm, and Vₐ=118 m/s,
m=b×6eB÷(πV)=39.25×10⁻²×6×1.8×1.6×10⁻¹⁹÷(3.14×118)=1.83×10⁻²¹ kg, that is, the mass M₀ of the particles that meets the effective condition for storing energy is 1.83×10⁻²¹ kg, i.e., M₀=m=1.83×10⁻²¹ kg.

Because the mass of a proton is 1.6×10⁻²⁷ kg, it can be seen that the mass of the particles that meets the effective condition for storing energy needs to be one million times greater than the mass of the proton. Therefore, positively charged aluminum trioxide (Al₂O₃) nanomaterials are selected.

d=10 nm, and the density of Al₂O₃ particles is 4 g/cm³, wherein d represents the diameter of Al₂O₃ particles.

M₃=4÷(10⁶×10⁶×10⁶)=4×10⁻¹⁸ (g/particle)=4×10⁻²¹ (kg/particle),

It can be seen that M₃>M₀, which meets the effective condition for storing energy.

R=M₃v÷(eB)=4×10⁻²¹×118÷(1.6×10⁻¹⁹×1.8)=1.63 m

a=V²÷R=118²÷1.63=8542 m/s²
wherein a represents an acceleration of the charged particles (unit: m/s²)

The amount of the charges in the energy storage ring is given by: Q=5×10⁻² C,
a charge Q₀ of 1C is equivalent to the charge carried by 6.25×10¹⁸ protons, i.e. Q₀=6.25×10¹⁸ electrons.

The amount of charges in the energy storage ring is given by: Q_{L}=Q_{L}×Q₀=5×10⁻²×6.25×10¹⁸=31.25×10¹⁶.

The mass m of the charged particles in the energy storage ring is 1.25 g, i.e., m=Q_{L}×M₀=31.25×10¹⁶×4×10⁻²¹=1.25×10⁻³ kg=1.25 g,

The length L of the rotor is 0.3 m, i.e., L=0.3 m, and the length L′ of the energy storage ring is 6 m, i.e., L′=6 m,
L′÷L=6 0.3=20 (times), a=8.542 km/s², when the charged particles are accelerated for 20 seconds, the charged particles of 1.25 g in the energy storage ring is accelerated to 8.542 km/s.

The energy storage speed of the energy storage ring can be increased to 600 km/s, 600×10³=(8.542×10³)=70.2 (times).

The time t₀ required to accelerate 1.25 g of the charged particles in the energy storage ring to 600 km/s is 1404 s, i.e., t₀=20 (s)×70.2=1404 (s).

### 5) in Energy Storage Ring, Selection of Neutral Gases, Calculation of Energy Storage Time, and Energy

Assuming that the energy storage time is 5 hours, then 5×3600=1404=12.8 times, argon gas is used as the neutral gases of the energy storage ring, the mass M_{y} of argon gas is 14.75 g, i.e., M_{y}=1.25×(12.8−1)=14.75 g,

that is, 5 hours of the energy storage time can make the total mass Mz of argon gas reach 16 g, i.e., Mz=1.25×12.8=16 g, and the energy storage speed of the charged particles and the neutral argon gas reach 600 km/s.

The total energy Wz=(½) mV²=(½)×16×10⁻³×(600×10³)²=28.8×108 J.

It is well known that one kilowatt-hour (KWh) of electric energy is equivalent to 3.6×10⁶ J, i.e., W₀=3.6×10⁶ J, wherein W₀ represents one kilowatt-hour (KWh) of electric energy,

so the total energy Wz is equivalent to 800 KWh of electric energy, i.e., Wz′=Wz÷W₀=28.8×10⁸÷(3.6×10⁶)=800 (degrees)

That is, the energy stored by charging the energy storage ring for 5 hours is equivalent to 800 degrees of electric energy.

### 6) Calculation of air Pressure in Energy Storage Ring

According to the volume V°° of the energy storage ring, i.e., V°°=27.6×10⁶ mm³=27.6 L≈1.2 Vₘ.

The mass of 1 mole of argon gas (whose molecular weight is 39) is about 39 g.

P≈14.75÷(39×1.2)=0.31 atm, wherein P represents the pressure in the energy storage ring.

### 7) Starting Method of Motor:

According to the effective condition for starting energy storage: Lₐ=(πb)/4, when b=τ=39.25 cm, Lₐ°=30 cm.

due to Lₐ=25 cm, Lₐ°=30 cm>Lₐ=25 cm meets the effective condition for starting energy storage.

According to M=b×2eB÷(πV₀), M=M₃=4×10⁻²¹ (kg/particle), b=τ=39.25 cm.

V₀=b×2eB÷(πM3)=0.3925×2×1.6×10⁻¹⁹×1.8÷(3.14×4×10⁻²¹).

V₀=18 m/s, that is, the circumferential speed V₀ of the rotor of the motor is 18 m/s when starting.

When b is the micrometer-level division size in the hollow tubes, the minimum requirement of the effective condition for starting energy storage is met.

The minimum requirement is given by: 1÷(4f)=πm÷(2eB)>b1=V,
wherein b1 the width of the hollow tubes, when b1=4bs=160 μm,

m=b1×(2eB)=(πV)=160×10⁻⁶×2×1.6×10⁻¹⁹×18(3.14×118)=248×10⁻²⁶ kg.

The mass of the proton is 1.6×10⁻²⁷ kg, M₀=m

M₀(1.6×10⁻²⁷)=24.8×10⁻²⁶÷(1.6×10⁻²⁷)=155 times

The charged particles whose molecular weight greater than 155 meet the effective condition for storing energy.

Gold ions are selected, the molecular weight of gold (Au) is 196, and gold ions are monovalent ions.

Mⱼ=196×1.6×10⁻²⁷=3.13×10⁻²⁵ kg,

R=Mⱼv÷(eB)=3.13×10⁻²⁵×118÷(1.6×10¹⁹×1.8)=128×10⁻⁶ m=0.12 mm,

a=U²÷R′=118²÷(128×10⁻⁶)=108×10⁶ m/s²

The value of the acceleration a reaches ⅓ the speed of light, which is very fast. The number of charged particles for storing energy is the same as mentioned earlier.

Q_{L}′=Q_{L}×Q₀=5×10⁻²×6.25×10¹⁶=31.25×10¹⁶,

The charged mass m″ of gold ions is 9.78×10⁻⁵ g, i.e., m″=Q_{L}×Mj=31.25×10¹⁶×3.13×10⁻²⁵=9.78×10⁻⁸ kg=9.78×10⁻⁵ g,

The charged mass of gold ions is only 9.78×10⁻⁵ g, which is very light.

Lₛ÷L′=20 times, a=108×10⁶ m/s.

Lₛ represents the length of the rotor, L′ represents the total length of the energy storage ring.

600×10³÷(108×10⁶)=5.55×10⁻³ s.

That is, after accelerating for 5.55×10⁻⁵ seconds, the speed of gold ions can be increased to 600 km/s and the time required is given by:

t₀=20×5.55×10⁻³=111×10⁻³ s.

Assuming that when the gold ions are accelerated for 5 hours, 9.78×10⁻⁵×n g of the gold ions is accelerated to 600 km/s,

Wherein n=5×3600÷(111×10⁻³)=162×10³ times.

The total mass Mn of gold ions is 10.68 g, i.e., Mn=9.78×10⁻⁵×n=9.78×10⁻⁵×111×10³=10.68 g.

The total mass of the required gold ions in the second method is close to that of the charged particles and the neutral gas in the first method, and the energy storage time and the stored energy of the second method are the same as those of the first method.

R″=MjV′÷(eb), V′=600 km/s.

R″=3.13×10⁻²⁵×600×10³÷(1.6×10⁻¹⁹×1.8)=0.652 m.

The radius of the storage energy ring is 0.4 m, and R″ can be reduced to 0.4 m so that charged particles move in a circular manner in the energy storage ring under the action of a magnetic field by appropriately increasing the value of b. After being constrained by both electric and magnetic fields in the energy storage ring, the charged particles can operate stably in the energy storage ring.

Charged particles with large mass are required to drive the start-up of energy storage, such as Al₂O₃ particles.

After starting the energy storage, Al₂O₃ particles are exported.

### 9) Comparison of Different Masses of Charged Particles

A first method is to select according to the polar distance, because the mass of the charged particles must be large enough, nanomaterials are selected. A second method is to select according to the micron-level gap, the mass of the charged particles can be very small, so ions are selected, but the ions need to be driven by a large mass of charged particles. Using the first method, the acceleration is small, only 7 km/s², so the impact on neutral molecules is relatively mild, but one disadvantage is that the magnetic confinement method cannot be used to confine the charged particles in the energy storage ring. Only direct current voltage can be used to confine the charged particles in the energy storage ring for stable operation. Using the second method, the acceleration is very large, up to ⅓ the speed of light. The impact on neutral gas molecules is intense and magnetic confinement can be used to confine charged particles in the energy storage ring. That is, a dual confinement (direct current voltage and magnetic confinement) method can be used to stabilize the operation of charged particles in the energy storage ring.

### 10) Estimation of Weight of DC Motor and Storage Energy Ring

An outer diameter Dj of the motor is 45.5 cm, i.e., Dj=45.5 cm, the length Lₐ of the armature is 25 cm, i.e., Lₐ=25 cm.

The height hs of the inner wall of the hollow tubes is 2.4 cm, i.e., hs=2.4 cm, the width bs of the inner wall of the hollow tubes is 0.685 cm, i.e., bs=0.685 cm.

The total length L of the storage energy ring is 600 cm, i.e., L=600 cm.

The density of iron is 7.8 g/cm³, i.e., ρ_{F}=7.8 g/cm³.

The weight Q₁ of the motor is 316 kg, i.e., Q₁=π×(Dj÷2)²×Lₐ×Fₛ=3.14×(45.5÷2)²×25×7.8=316×10³ g=316 kg.

The density ρ_{P} of glass is 2.45 g/cm³, i.e., ρ_{P}=2.45 g/cm³, the density p_{N} of nickel is 8.9 g/cm³, i.e., p_{N}=8.9 g/cm³.

The volume occupied by the nickel plating layer in the hollow tubes is equivalent to the volume of gas in the hollow tubes:

V″=27.6×10⁶ mm³=27.6×10³ cm³.

Since the density of nickel is 3.6 times that of glass and the volume of nickel is only ⅓ that of glass, the weight of nickel is approximately taken as 1.8 times the weight of the glass film, i.e., Q₂=1.8,

V″Ps=1.8×27.6×10³×2.45=121×10³ g=121 kg.

The density ρ_{y} of the insulating material (i.e., mica) is 2.8 g/cm³, i.e., ρ_{y}=2.8 g/cm³ and the area Sₘ of mica is 195×10³ cm², i.e., Sₘ=(2hs+2bs)×L×Z=(2×2.6+2×0.8)×6×100×48=195×10³ cm².

The thickness δ of mica is 0.5 mm, i.e., δ=0.5 mm.

Q₃=Sₘδρ_{y}=195×10³×0.5×10⁻¹×2.8=26.4×10³ g=27 kg.

The fixed hollow tubes in the storage energy ring adopt a titanium alloy shell with an area equal to that of the ceramic,

Sₘ=189.2×10³ cm², δ=0.5 mm, ρₜ=4.5 g/cm³, wherein δ represents the thickness of titanium alloy, pₜ represents the density of titanium alloy.

Q₄=Sₘδρₜ=195×10³×0.5×10⁻¹×4.5=42.5×10³ g=43.8 kg.

Q=Q₁+Q₂+Q₃+Q₄=316+121+27+43.8=508 kg, wherein Q represents the total weight of the motor.

Considering that when the prime mover DC motor and the DC storage motor are integrated together, a commutator needs to be introduced, and the total weight of the motor will increase. When the shell of the motor is changed to titanium alloy, the total weight of the motor will decrease. At this time, the total weight of the motor is estimated to be 510 kg.

### Application 2: Electric Aircrafts

The structure of the DC storage energy motor for the electric aircrafts is basically the same as that of the DC storage energy motor for the electric vehicles.

### 1) Selection of Main Parameters and Dimensions of Motor

The power of each motor is 120,000 kW, the number of the motors is 2,

n_{N}=9000 rpm, P_{N}÷n_{N}=11, Dₐ=110 cm,

B=1.6 Wb/m², Dj=200 cm, and 2p=4, wherein Dj represents the outer diameter of a stator.

Z÷(2p)=24, Z=24×4=96, Lₐ=65 cm, wherein Lₐ represents the length of the armature.

The polar distance τ=πDₐ÷(2p)=3.14×110÷4=86.35 cm.

According to the effective condition for starting energy storage Lₐ°=(πb)÷4, when b=τ=86.35 cm,

Lₐ°=(3.14×86.35)=4=67.7 cm, which is larger than Lₐ=65 cm (Lₐ°=67.7 cm>Lₐ=65 cm) and meets the starting condition.

the pitch ta=πDₐ÷Z=3.14×110÷96=3.6 cm.

bs=ta 2=1.8 cm, hs=24 mm, wherein bs represents the width of the inner wall of the hollow tubes, hs represents the height of the inner wall of hollow tubes.

The electromotive force eₐᵥ of the rotor hollow tubes is given by:

eₐᵥ=2pφn÷60=2pB₁ Ln÷60=2×2×1.6×0.8635×0.65×9000÷60=538 (v)

Assuming that the radius R of the energy storage ring is 5 m, and the circumference L of the energy storage ring is 80 m, i.e., R=5 m, L=80 m.

### 2) Calculation of the Division Structure and Materials of Hollow Tubes

The gap between the two films in the hollow tubes is 40 microns, and the structure and materials are the same as those of the above electric vehicles.

### 3) Calculation of the Density of Charged Particles, the Current of Rotor, and the Power of Rotor

u=Q_{R}÷(4πε₀r), u=538 V, r=40÷2=20 μm,

Q_{R}=4πε₀r×u=4π×1÷(36π)×10⁻⁹×20×10⁻⁶×538=1195×10⁻¹⁵,

ρ₀=Q_{R}÷V₄, V₄=40×40×40 μm³

ρ₀=1195×10⁻¹⁵=(40×10⁻³)³=18.68×10⁻⁹ (C/mm³),
ρ₀ represents the charge density of the charged particles (C/mm³),
Vₛ=hs×(bs÷2)×L×Z=24×(18÷2)×80×10³×96=1658.8×10⁶ mm³, wherein Vₛ represents the volume of gas in the hollow tubes,

The amount of charges carried by the charged particles in the storage energy ring is given by: Q_{L}=Vₛ×ρ₀=1658.8×10⁶×18.68×10⁻⁹=30.9(C).

The speed of the charged particles and the neutral gas in the storage energy ring is increased to 600 km/s, and the circumference of the storage energy ring is 80 meters,
then f=600×10³, 80=7.5×10³ cycles per second,
I=Q_{L}f=30.9×7.5×10³=231×10³ A, wherein I represents the current in the storage energy ring,
A=I÷(πDₐ)=231×10³÷(3.14×110)=668 A/cm, wherein A represents the linear charge of the motor,
W=Iu=231×103×538=124×10⁶ VA=124M VA, wherein W represents the power of the motor,

### 4) Selection of the Charged Particles and the Neutral Gas Molecules

The effective condition for starting energy storage of the charged particles is given by: 1÷(12f)=π m÷(6eB)≥b÷V, wherein b=b3, and b3 is the polar distance,
the polar distance T=86.35 cm, V=Vₐ,
Vₐ=πDₐ×n÷60=3.14×1.1×9000÷60=518 m/s,
m=τ÷(πVₐ)×6eb=86.35×10²÷(3.14×518)×6×1.6×1.6×10⁻¹⁹=8.15×10⁻²² kg/particle,
therefore, Al₂O₃ nanomaterials are selected as the charged particles.
M₃=4×10⁻²¹ kg/particle,
R=M₃v÷(eB)=4×10⁻²¹×518÷(1.6×10⁻¹⁹×1.6)=8.09 m,
a=V², R=518², 8.09=33 km/s², that is, the acceleration a of the charged particles is 33 km/s².

The amount of charges carried by the charged particles in the storage energy ring is given by: Q_{L}=30.9(C), a charge Q₀ of 1C is equivalent to the charge carried by 6.25×10¹⁸ protons, i.e. Q₀=6.25×10¹⁸ electrons.

m″=Q_{L}×Q₀×M₃=30.9×6.25×10¹8×4×10⁻²¹=0.7725 kg, wherein m″ represents the mass of the charged particles,
argon gas (whose molecular weight is 39) is selected to be the neutral gas.

### 5) Calculation of Energy Storage Time and Storage Energy

Lₐ=0.65 m, and L=80 m, wherein Lₐ represents the length of the rotor, L represents the total length of the storage energy ring.

L÷Lₐ=80÷0.65=123 (times), α=33 km/s²
that is, the motor is accelerated for 123 seconds, the speed of 0.7725 kg of charged particles in the energy storage ring is increased to 33 km/s.

In order to increase the speed of 0.7725 kg of the charged particles to 600 km/s, the motor is accelerated for 2236 seconds. The calculation is below: 600÷33=18.18 times,
t=123×18.18=2236 seconds, that is, it takes 2236 seconds to increase the speed of 0.7725 kg of charged particles to 600 km/s. If charging for 10 hours, the speed of 12.437 kg of the charged particles and the neutral gas can be increased to 600 km/s, the calculation is below:

t_{N}=10×3600÷2236=16.1 times,
m=m″t_{N}=0.7725×16.1=12.437 kg, wherein m represents the total mass of the charged particles and the neutral gas,
the total energy W_{Z}=(½)mV²=(½)×12.437×(600×10³)²=223.8×10¹⁰ J,
the calorific value W′ of each kilogram of gasoline is 4.6×10⁷ J/Kg, i.e., W′=4.6×10⁷ J/Kg, then m′_{gasoline}=W_{Z}÷W′=223.8×10¹⁰ (4.6×10⁷)=48.6×10³ kg, which is equivalent to the energy stored by 48.6 tons of gasoline.

The energy stored by two DC storage energy motors is equivalent to the energy stored by 2×48.6=97.3 tons of gasoline. Since the efficiency of electric energy is three times that of gasoline, the energy stored by two DC storage energy motors is equivalent to the energy stored by 3×97.3=292 tons of gasoline.

### 6) Calculation of Air Pressure in Energy Storage Ring

The volume Vₛ of the energy storage ring is 1658.8 L, i.e., Vₛ=1658.8×10⁶ (m³)=1658.8 L
Vₘ=22.4/mol (the molecular weight of argon is 39)
V=Vₛ 22.4=74 (moles),
m_{Argon}=74×39=2886 g=2.886 kg, wherein m_{Argon} represents the mass of argon at one atmosphere,
M_{Z}=12.437 kg, wherein M_{Z} represents the total mass of the energy storage ring,
M_{Z}÷m_{Argon}=12.437÷2.886=4.3 atmospheres,
that is, when the pressure of argon in the above energy storage ring reaches 4.3 atmospheres, the total mass of the energy storage ring reaches 12.437 kg.

### 7) Starting Method of Motor

According to the effective condition for starting energy storage: Lₐ°=(πb) 4, when b=τ=86.35 cm,
Lₐ°=67.7 cm, which is larger than Lₐ=65 cm (i.e., Lₐ°=67.7 cm>Lₐ=65 cm) and meets the effective condition for starting energy storage.

According to M=b×2eB÷(πV₀), M=M₃=4×10⁻²¹ (kg/particle), b=T=86.35 cm,
V₀=b×2eB÷(πM₃)=0.8635×2×1.6×10⁻¹⁹×1.6 (3.14×4×10⁻²¹),
V₀=35 m/s, that is, the circumferential speed of the rotor of the motor is 35 m/s when starting.

### 8) Estimation of the Weight of DC Motor and Energy Storage Ring

Dj=200 cm, and Lₐ=65 cm, wherein Dj represents the outer diameter of the motor, Lₐ represents the length of the armature.

hs=2.6 cm, bs=18 mm, Z=96, wherein hs represents the height of the inner wall of the hollow tubes, bs represents the width of the inner wall of the hollow tubes.

L=80 m, ρ_{F}=7.8 g/cm³, and ρ_{N}=8.9 g/cm³, wherein L represents the total length of the energy storage ring, ρ_{F} represents the density of the iron, ρ_{N} represents the density of nickel.

ρ_{P}=2.45 g/cm³, wherein pp represents the density of the glass film.

Q₁=π×(Dj÷2)²×Lₐ×ρ_{F}=3.14×(2÷2)²×0.65×7.8=15.9 tons, wherein Q₁ represents the weight of the motor. The shell of the motor is made of titanium alloy, which greatly reduces the weight of the motor. When an external motor and the storage energy motor are integrated into the motor, the weight of the motor increases and the weight of the motor is estimated to be 18 tons.

Considering the weight Q₂ of the glass film is given by: Q₂=1.8Vₛρ_{P}=1.8×1658.8×10³×2.45=7315×10³ g=7.3 tons

The weight Q₃ of a mica interlayer, ρ_{y} (representing the density of mica)=2.8 g/cm³, the area Sₘ of mica is given by:

Sₘ=(2hs+2bs)×L×Z=(2×2.4+2×1.8)×80×100×96=6.45×10⁶ cm²

δ=1 mm, wherein δ represents the thickness of mica.

Q₃=Sₘδρ_{y}=6.45×10⁶×0.1×2.8=1.8×10⁶ g=1.8 tons

The weight Q₄ of an outer shell of the hollow tubes, ρₜ=4.5 g/cm³, 5=1 mm, wherein ρₜ represents the density of titanium alloy, δ represents the thickness of titanium alloy,
Sₘ=6.45×10⁶ cm², wherein Sₘ represents the surface area of titanium alloy,
Q₄=Sₘδρₜ=6.45×10⁶×0.1×4.5=2.9×10⁶ g=2.9 tons,
the total weight Q=Q₁+Q₂+Q₃+Q₄=18+7.3+1.8+2.9=30 tons,
the weight of the two motors is 2×30=60 tons.

### 9) Calculation of Load, Effective Load, and Flight Distance of Aircrafts

The power of each motor is 124 MW, and the total power of two motors is 248,000 kW, which is equivalent to the energy stored by 292 tons of gasoline.

The aircraft has a full load of 230 tons and an empty aircraft weighs 40% of its fully loaded aircraft, so the weight m (not considering the weight of the DC energy storage motor) of an aircraft when it is empty is 92 tons, i.e., m=230×0.4=92; the weight of two DC energy storage motors is 60 tons, the weight m′ (considering the weight of the DC energy storage motor) of an aircraft when it is empty is 152 tons, i.e., m′=92+60=152, and the effective load m_{Effective} of the aircraft is 78 tons, i.e., m_{Effective}=230−152=78.

Since 292 tons far exceeds 230 tons, with the same weight, an aircraft powered by two DC energy storage motors can fly further than any modern aircraft and its load can be increased to 33%, which also exceeds that of any modern aircraft.

### Application 3: Spacecrafts

The power, size, and structure of the DC motor of the spacecrafts are basically the same as those of the electric aircrafts. Considering that the spacecrafts need more energy, the material of the neutral gas medium can choose a gas with a large molecular weight, e.g., SF6 (sulfur hexafluoride) gas whose molecular weight is (32+6×19)=146. Under the same molar gas condition, the mass of the SF6 gas is n times that of argon gas, wherein n=146 39=3.7. In this way, the energy storage of the spacecrafts can be increased by 3.7 times compared to that of the electric aircrafts.

According to previous calculations:
The power of each motor is 124000 kW and the power of the two motors is 2×124000=248 MW,
n_{N}=9000 rpm, Dₐ=110 cm, Lₛ=65 cm, wherein Lₛ represents the length of the armature.

Dj=200 cm, 2p=4, Z÷2p=24, wherein Dj represents the outer diameter of the stator,

Z=24×4=96, Lₛ=65 cm.

The energy storage speed is 600 km/s, and the length of the energy storage ring is 80 m.
when the speed of Al₂O₃ with the mass m₀ is accelerated to 600 km/s, the acceleration time Δt required is 2236 seconds,
i.e., Δt=2236 s.

Vₛ=1658.8×10⁶ L, wherein Vₛ represents the volume of gas in the energy storage ring.

nₘ=Vₛ÷22.4=1658.8÷22.4=74 (moles), wherein nₘ represents the number of moles of gas.

Assuming that after SF6 gas is injected into the energy storage ring, the pressure reaches 20 atmospheres (i.e., P20), molecular weight of m₁₄₆-SF₆

m₆ (the mass of SF₆ gas)=πm×P₂₀×m₁₄₆=74×146×20=216×10³ g=216 kg, the required acceleration time is given by:

t=(m₆÷m₀)×Δt=(216÷0.7725)×2236=625211 s=173 h.

216 kilograms of SF6 gas is accelerated for 173 hours to make the speed of SF6 gas reach 600 km/s,
W=(½)mV²=(½)×216×(600×10³)²=3888×10¹⁰ J, wherein W represents the energy stored by each DC motor,
W′=4.6×107 J/Kg, wherein W′ represents the calorific value of each kilogram of gasoline,
m_{gasoline′}=W÷W′=3888×10¹⁰ (4.6×10⁷)=845×10³ kg, which is equivalent to the energy stored by 845 tons of gasoline.

Energy provided by two DC energy storage motors is equivalent to energy stored by 2×845=1690 tons of gasoline. Assuming that the full load of a spacecraft is 239 tons, then 1690÷239=7 times, the energy stored by the spacecraft when fully loaded is equivalent to the energy provided by 1690 tons (which is 7 times the full load weight of the spacecraft) of gasoline. If these charged particles are used to propel spacecrafts, it will be a new and efficient aerospace energy storage conversion device that can both generate electricity and propel the spacecraft.

### Application 4: Solar Energy Storage, Wind Energy Storage, Grid Energy Storage, and Peak Shaving

The advantage of the DC energy storage motor is that it can store large amounts of energy and be used as an electric motor. As mentioned earlier, the DC motor can be used as the prime mover to drive the DC energy storage motor to store energy and the motor of the prime mover and the DC energy storage motor are integrated into a DC motor. Only a DC power supply needs to be provided to make the DC motor act as a prime mover, thereby driving the DC energy storage motor to store energy. If the DC energy storage motor is used as an electric motor, the motor of the original DC prime mover is connected to an external network to output DC power supply, then the DC power supply is converted into an alternating current (AC) power supply for power supply to a power grid.

Whether it is solar energy, wind energy or surplus electricity from the grid at night, all are converted into DC electricity to drive the DC motor to drive the DC storage motor to store energy. When electricity is needed, the DC energy storage motor that stores electric energy is operated. The DC energy storage motor generates DC electricity, DC electricity is output to the DC power supply through the connected external network, and then DC electricity is converted into AC electricity, which can play a role in peak shaving.

If a power grid needs to store energy as backup power, previously mentioned spacecrafts, and the DC energy storage motor can be used for storing energy. The energy stored by two 124 MW DC energy storage motors can be used for 173 hours, and is equivalent to the electric energy provided by 1690 tons of gasoline. When the grid needs electricity, two 124 MW DC energy storage motors can supply power continuously for a week.

If peak shaving is needed for a power grid, the aircraft's DC energy storage motor can be used for storing energy. Two 124 MW DC energy storage motors are charged for 10 hours to store energy, the stored energy is equivalent to electricity provided by 2×48.6=97.3 tons of gasoline. During peak electricity usage on the power grid, two 124 MW DC energy storage motors can provide continuous power for 8 hours.

Application 5: High-Power Heavy Ion Accelerators and Neutron Sources and their Applications

### (1) High-Power Heavy Ion Accelerators

The structure of the DC energy storage motor of the high-power heavy ion accelerators is similar to that of the DC energy storage motor of electric aircrafts. The difference is that the speed of ions can be increased to near the speed of light in the high-power heavy ion accelerators, so injection of neutral gas mediums is not needed.

### 1) Main Parameters and Dimensions of Motor

P_{N}=600 kw, n_{N}=1500 rpm, wherein P_{N} represents the power of the motor, n_{N} represents the rotating speed of the motor, P_{N}÷n_{N}=600÷1500=0.4, Dₐ=150 cm,
Dj=Dₐ÷0.55≈273 cm, wherein Dj represents the outer diameter of the stator,
B=0.1 Wb/m², 2p=4,
Z÷(2p)=24, Z=24×4=96, Lₐ=16 cm, wherein Lₐ represents the length of the armature,
the pitch ta=πDₐ÷Z=3.14×150÷96=4.9 cm,
the polar distance τ=πDₐ÷2p=3.14×150÷4=117 cm,
Vₐ=πDₐ×n÷60=3.14×1.5×1500÷60=117 m/s,
According to the starting condition: Lₐ°=(πb)÷4, when b=τ=117 cm,
Lₐ°=(πT)÷4=(3.14×117) 4=91.8 cm, which is greater than Lₐ=16 cm, i.e., Lₐ°=91.8 cm>Lₐ=16 cm.

It can be seen that when b=T, it meets the effective condition for starting energy storage.
bs=ta÷2=4.9÷2=2.45 cm, wherein bs represents the width of the inner wall of the hollow tubes
hs=bs=2.45 cm, wherein hs represents the height of the inner wall of the hollow tubes,
eₐᵥ=2pφn=60=2pBτLₐ×n=60=4×0.1×1.17×0.16×1500=60=1.872(v),

Assuming that the radius R of the energy storage ring is 5 m and the total length L of the energy storage ring is 36 m.

### 2) Calculation of Division Structure, Material, Voltage and Power of Hollow Tubes

The gap between the adjacent hollow tubes is 40 microns, and the structure and material are the same as those of the above electric vehicles.

### 3) Calculation of Density and Voltage of Charged Particles

u=Q_{R}÷(4πε₀r), u=1.872 V, r=40 2=20 μm,
Q_{R}=4πε₀r×u=4π×1÷(36π)×10⁻⁹×20×10⁻⁶×1.872=4.16×10¹⁵ C
ρ₀=Q_{R}÷V₄, V₄=40×40×40 μm³
ρ₀=4.16×10¹⁵ (40×10⁻³)³=0.065×10⁻⁹ (C/mm³),
ρ₀ represents the density of the charged particles,
Vₛ=hs×(bs÷2)×L×Z=24.5×(24.5÷2)×36×103×96=1037.2×10⁶ mm³, wherein Vₛ represents the volume of the gas in the hollow tubes,
Q_{L}=Vₛ×ρ₀=1037.2×106×0.065×10⁻⁹=67.4×10⁻³ C, wherein Q_{L} represents the total amount of charges carried by the charged particles in the energy storage ring.

According to the effective acceleration condition of the charged particles: 1÷(12f)=π m÷(6eB)≥b÷V, wherein b=160 μm,
m=b=(πV)×6eB=160×10⁻⁶÷(3.14×117)×6×1.6×10⁻¹⁹×0.1=4.2×10⁻²⁶ kg, M₀=m

Therefore, potassium ions (K⁺) are selected, the molecular weight of K⁺ is 39, the mass of protons is 1.6×10⁻²⁷ kg, and the mass mₖ of potassium ions is 6.24×10⁻²⁶ kg, i.e., mₖ=1.6×10⁻²⁷×39=6.24×10⁻²⁶ kg. It can be seen that mₖ>M₀, the effective acceleration condition is met.

4) Calculation of Energy Storage Time, Power and Beam Size: R=mₖVₐ÷(eB)=6.24×10⁻²⁶×117÷(1.6×10¹⁹×0.1)=456.3×10⁻⁶ m,
a=Vₐ², R=1172 (456.3×10⁻⁶)=3×10⁷ m/s².

Lₐ=0.16 m, L=36 m, wherein Lₐ represents the length of the rotor, L represents the total length of the energy storage ring,
L÷Lₐ=36÷0.16=225 (times), assuming that the acceleration time of the rotor hollow tubes is 225 seconds, when the speed of the charged particles is increased for 225 seconds, the speed V of the charged particles in the energy storage ring will be increased to 3×10⁷ m/s², i.e., V=3×10⁷ m/s².

When V′=6V=6×30×10⁶=1.8×10⁸ m/s,
the acceleration time t=225×6=1350 s, the speed of the charged particles reaches 60% the speed of light.

The energy storage ring accelerates to 60% the speed of light, that is, V′=1.8×10⁸ m/s, and the radius of the energy storage ring is 5 m,
The circumference of the energy storage ring is 36 m, then f=1.8×10⁸÷36=5×10⁶ cycles per second.

The total amount of charges Q_{L} in the energy storage ring is 67.4×10⁻³³, I=_{R}×f=67.4×10⁻³×5×10⁶=337×10³ A, wherein I represents the current of the energy storage ring.

The linear charge of the motor is given by: A=I÷(πDₐ)=337×10³÷(3.14×150)=715 A/cm, wherein A represents the linear charge of the motor.

W=UI=337×10³×1.872=630×10³ VA=630 KVA, wherein W represents the power of the motor.

Q_{L}=67.4×10³, Q₀=6.25×10¹⁸, wherein Q_{L} represents the total amount of charges in the energy storage ring.

The total amount of charges Q_{L}° in the energy storage ring is given by: Q_{L}=Q_{L}Q₀=67.4×10⁻³×6.25×10¹8=421.25×10¹⁵ (the amount of charges), if 10¹⁴ charged particles are output per second, the output time tⱼ can be 4212.5 s, i.e., tⱼ=421.25×10¹⁵÷10¹⁴=4212.5 s. However, the energy storage time of the heavy ion accelerators is only 1350 seconds.

If two heavy ion accelerators are used alternately, it is possible to output 10¹⁴ charged particles per second without interruption.

### 5) Calculation of Air Pressure in Energy Storage Ring:

the amount of charges Q_{L}°=421.25×10¹⁵, the volume Vₛ of gas in the hollow tubes,
Vₛ=1037.2×10⁶ mm³=1037.2 L, Vₛ 22.4=46 mol,
The number of molecules N₀ in 1 mole of gas is 6.02×10²³, i.e., N₀=6.02×10²³

Q_{L}°=421.25×10¹⁵, Q_{L}° represents the number of charges in the hollow tubes,
P_{Y}=Q_{L}°÷(46N₀)=421.25×10¹⁵ (46×6.02×10²³)=1.52×10⁻⁸ atmospheres=1.52×10⁻³ Pa, wherein P_{Y} represents the pressure in the hollow tubes.

### 6) Starting Method of Motor

Since b=b1=160 μm, it does not meet the effective condition for starting energy storage. Large-mass charged particles need to be injected, so Al₂O₃ is selected as the large-mass charged particle for starting the motor to drive potassium ions.

According to the minimum speed of potassium ions which meets the effective condition for starting energy storage: M=b×2eB÷(πV₀),
b=b1=160 μm,
M=6.24×10⁻²⁶ kg,
V₀=b×2eB÷(πM)=160×10⁻⁶×2×1.6×10¹⁹×0.1÷(3.14×6.24×10⁻²⁶)=26 m/s,
Lₐ=(b÷V₀) V₀°, wherein V₀° represents the minimum speed of the starting charged particles,
V₀°=Lₐ÷(b÷V₀)=0.16 (160×10⁻⁶÷26)=26×10³ m/s,
the motor is started according to the starting condition of Al₂O₃, and when the speed of the charged particles reaches 26×10³ m/s,
the motor is started again according to the starting condition of potassium ions, that is, the speed of the rotor is 26 m/s at startup. Then, the charged particles (Al₂O₃) are exported.

### 7) Calculation of Magnetic Confinement

R°=mₖV°÷(eB), V′=1.8×10⁸ m/s, B=0.1 mₖ=6.24×10⁻²⁶ kg.

R°=6.24×10⁻²⁶×1.8×10⁸÷(1.6×10⁻¹⁹×0.1)=702 m.

When R°°=5 m, R°°=mₖV°÷(eBₓ), wherein R°° represents the radius of the energy storage ring,
Bₓ=mₖV°÷(e R°°)=6.24×10⁻²⁶×1.8×10⁸÷(1.6×10⁻¹⁹×5)=14.04 Wb/m² when the radius R°° of the energy storage ring is 5 meters, a magnetic field is installed on the radius R°° of the energy storage ring.

Bₓ=14.04, after several symmetrical magnetic constraints, the charged potassium ions can be well constrained in the energy storage ring with the radius R and also constrained by the DC voltage. In this way, after double constraints, the reliability of the operation of charged particles has greatly increased.

### (2) Neutron Sources

On the basis of the 630 kW heavy ion accelerator described above, neutrons can be generated by bombarding a target nucleus to obtain a neutron source accelerator. The output speed of heavy ions (i.e., potassium ions) is 60% the speed of light, a beam strength of heavy ions is 10¹⁴ per second and can be continuously output for 4200 seconds. If for every heavy ion that bombards the target nucleus, 10 neutrons are generated, then the beam of the neutron source produced by these heavy ions bombarding the target nucleus can reach 10¹⁵ neutrons per second and can also last for 4200 seconds. At this time, the power of the neutron source reaches 630 kW, which is already quite high.

### (3) Applications of Neutron Sources

1) Application in medicine. Using the characteristic that boron ions easily aggregate cancer cells: boron ions are used to aggregate cancer cells, and then the neutron source irradiates the boron ions to make the boron ions release neutrons to kill cancer cells. If the intensity of the neutron source is too strong, it can be adjusted by a moderator to minimize the impact on the human body while still stimulating the boron ions to release neutrons to kill cancer cells.

### 2) Application in Nuclear Power Plants

The principle of fission and power generation of nuclear is that the nucleus undergoes fission to produce neutrons, produces a chain reaction to continuously produce neutrons, continuously undergoes fission to release energy, and then generates electricity. If too many neutrons are produced too quickly, it can cause a loss of control and result in a very serious nuclear reactor explosion that causes pollution.

If the neutrons produced by the above-mentioned neutron source are used to irradiate the nucleus, nucleus fission produces energy. If the chain reaction for producing neutrons is too fast and too large, once it is out of control, just turn off the neutron source. When the neutron source is no longer irradiating the nucleus, the chain reaction for producing neutrons stops immediately which will not cause an explosion. Using nuclear fission to generate electricity becomes very safe.

The sixth application: high-power deuterium and tritium accelerators for producing fusion reactions

According to known information, deuterium and tritium is accelerated to 70% the speed of light and collide to produce fusion reactions.

### (1) Calculation of Energy Gains and Losses

Deuterium: D=2H, molecular weight of deuterium is 4. When one gram of deuterium is accelerated to 70% the speed of light, the energy is:

W_{H}=(½)mV²=(½)×1×10⁻³×(3×10⁸×70%)²=2.205×10¹³ J. Since the energy released by the fusion of one thousand kilograms of deuterium is equivalent to the energy provided by 11,000 tons of coal, the energy released by the fusion of one gram of deuterium is equivalent to the energy provided by 11 tons of coal. The calorific value of one kilogram of coal is 29.308 MJ and the calorific value W_{M} of 11 tons of coal is 3.22×10¹¹ J, i.e., W_{M}=11×10³×29.308=3.22×10⁵ MJ=3.22×10¹¹ J.

It can be seen that the energy required to accelerate one gram of deuterium to 70% the speed of light far exceeds the energy released by the fusion of one gram of deuterium. Since the efficiency of converting kinetic energy into electric energy is generally less than 50%, it is not cost-effective to use fusion reactions by accelerating one gram of deuterium to 70% the speed of light.

Conclusion: Accelerating deuterium and tritium to 70% the speed of light can only serve as an ignition function.

According to known information, if the temperature of deuterium and tritium is to be maintained at 100 million Celsius, the confinement time for nuclear fusion is given by:

When nτ≥10¹⁴ S/cm³, fusion reactions can be continuously maintained.

In summary: Deuterium and tritium can be used as ignition devices for fusion reactions when accelerated to 70% the speed of light.

The energy W_{H} required to accelerate one gram of deuterium to reach the temperature of 100 million Celsius is 10⁸×Cp, i.e., W_{H}=(½)mV²=10⁸×Cp,
Cp=7.243 KJ/(kgK), wherein Cp represents specific heat capacity for deuterium,

The energy required to accelerate one gram of deuterium to reach the temperature of 100 million Celsius is 10⁸×7.243×10³÷10³=7.243×10⁸ J.

W_{H}=(½)×1×10⁻³V².

W_{H}=(½) mV²=10⁸×Cp,

(½)×1×10⁻³V²=7.243×10⁸,

V²=14.486×10¹¹,

V=1202 km/s.

If two beams of deuterium collide at a speed of 1202 km/s, the temperature of deuterium can reach 100 million Celsius.

The energy W_{H}″ required to accelerate each gram of deuterium to a speed of 1202 km/s is

7.243×10⁸ J, i.e., W_{H}″=(½) mV²=(½)×1×10⁻³×(1202×10³)²=7.243×10⁸ J.

The energy Wₘ released by each gram of deuterium fusion is 3.22×10¹¹ J, i.e., Wₘ=3.22×10¹¹ J.

Wₘ÷W_{H}″=3.22×10¹¹ (7.2×10⁸)=447 times. It can be seen that deuterium and tritium collide at a speed of 1202 km/s, the temperature can reach 100 million Celsius and the required energy is only 1/447 of the released energy. Therefore, there are two types of accelerators for deuterium and tritium, one that reaches 70% the speed of light and another that reaches 1200 km/s. The accelerator that reaches 70% the speed of light is used to ignite to produce fusion reactions, while the accelerator that reaches 1200 km/s is used to add fusion fuel.

When the temperature reach 100 million Celsius and nτ≥10¹⁴ S/cm³, the accelerator that reaches 1200 km/s can produce continuous fusion reactions by continuously burning.

(2) Deuterium and Tritium Accelerators with Speed of 70% the Speed of Light

Assuming that Dₐ=300 cm, n_{N}=1500 rpm,
Vₐ=πDₐ×n÷60=3.14×3×1500÷60=235.5 m/s,
According to the effective condition for storing energy of the charged particles: 1÷(12f)=π m÷(6eB)≥b÷V, and b=160 μm,
the molecular weight of deuterium is 4, and m₄=4×1.6×10⁻²⁷=6.4×10⁻²⁷ kg/particle.

B=πm₄Vₐ÷(6×eb)=3.14×6.4×10⁻²⁷×235.5÷(6×1.6×10⁻¹⁹×160×10⁻⁶)=3.08×10⁻² Wb/m², B=0.02 Wb/m², Lₐ=30 cm, wherein Lₐ represents the length of the armature.

Z÷(2p)=36, 2p=4, Z=36×4=144,

the pitch ta=πDₐ÷Z=3.14×300÷144=6.54 cm,

τ=πDₐ÷(2p)=3.14×300÷4=235.6 cm,

According to the effective condition for starting energy storage: Lₐ°=(πb)÷4, when b=τ=235.6 cm,
Lₐ°=(πb)÷4=(3.14×2.356)÷4=1.8 m, which is greater than Lₐ=30 cm, i.e., Lₐ°=1.8 m>Lₐ=30 cm, and meets the effective condition for starting energy storage.

bs=ta÷2=6.54÷2=3.27 cm, and hs=2.6 cm, wherein bs represents the width of the inner wall of the hollow tubes.

R=5 m, L=36 m, wherein R represents the radius of the energy storage ring, L represents the circumference of the energy storage ring; when the energy storage speed reaches 70% the speed of light,

V=3×10⁸×70%=2.1×10⁸ m/s,

eₐᵥ=2pφn÷60=2pBτLₐ×n÷60=4×0.02×2.356×0.3×1500÷60=1.4136 (v).

The structure and material of the hollow tubes of the energy storage ring are similar to those mentioned earlier, with a spacing of 40 microns.

u=Q_{R}÷(4πε₀r), u=1.4136 v, r=40÷2=20 μm,

Q_{R}=4πε₀r×u=4π×1÷(36π)×10⁻⁹×20×10⁻⁶×1.4136=3.14133×10⁻¹⁵ C,

ρ₀=Q_{R}÷V₄, V₄=40×40×40 μm³,

ρ₀=3.14133×10⁻¹⁵÷(40×10⁻³)³=0.049×10⁻⁹ (C/mm³),
ρ₀ represents the density of the charged particles,
Vₛ=hs×(bs÷2)×L×Z=32.7×(26÷2)×36×10³×144=2203.7×10⁶ mm³, wherein V, represents the volume of gas in the energy storage hollow tubes.

Q_{L}=Vₛ×ρ₀=2203.7×10⁶×4.9×10⁻¹¹=0.10798 C, wherein Q_{L} represents the total amount of charges in the energy storage ring.

The charged particles in the energy storage ring are accelerated to 2.1×10¹ m/s, and the circumference of the energy storage ring is 36 m.
the frequency f=2.1×10⁶÷36=5.833×10⁶ cycles per second,
I_{f}=Q_{L}f=0.10798×5.833×10⁶=629.8×10³ A, wherein I_{f} represents the current in the energy storage ring.

A°=I_{f}÷(πDₐ)=629.8×10³÷(3.14×300)=668.5 A/cm, which meets the requirements, wherein A° represents the linear charge of the motor.

W=Iu=629.8×10³×1.4136=890×10³ W=890 kW, wherein W represents the power of the motor.

R°=m₄V°÷(eB)=6.4×10⁻²⁷×235.5÷(1.6×10⁻¹⁹×0.02)=471×10⁻⁶ m.

A=V²÷R′=235.5²÷(471×10⁻⁶)=1.17×10⁸ m/s²

Lₐ=0.3 m, L=36 m, wherein Lₐ represents the length of the rotor, L represents the total length of the energy storage ring.

L÷Lₐ=36÷0.3=120 (times), that is, when the energy storage ring is accelerated for 120 seconds, the charged particles in the energy storage ring is accelerated to 1.17×10⁶ m/s². When the energy storage ring is accelerated for 2×120=240 seconds, the charged particles in the energy storage ring is accelerated to 2×1.17×10⁸ m/s²=2.34×10⁸ m/s² which meets the speed requirement.

The amount of charges Q_{L} in the energy storage ring is 0.10798 C, i.e., Q_{L} 0.10798 C.

The amount of charges Q_{L}° carried by the charged particles in the energy storage ring is given by: Q_{L}=Q_{L}×Q₀, a charge Q0 of 1C is equivalent to the charge carried by 6.25×10¹⁸ protons, i.e. Q₀=6.25×10¹⁸ electrons.
Q_{L}°=0.10789×6.25×10¹⁸=0.6743×10¹⁸ (the amount of charges)

The mass M_{H}° of deuterium in the energy storage ring is given by: M_{H}°=Q_{L}×4m₀, m₀=1.6×10⁻²⁷ kg (the mass of a proton),

M_{H}°=0.6743×10¹8×4×1.6×10⁻²⁷=4.31552×10⁻⁹ kg=4.31552×10⁻⁶ g

When the energy storage ring is accelerated for 240 seconds, 4.31552×10⁻⁶ g of the charged particles can be accelerated to 2.4×10⁸ m/s.

Assuming that the amount of charges Q_{L} output in 240 seconds are 0.6743×10¹⁸, the amount of charges Q_{L}° output in a second is 2.8×10¹⁵,
i.e., Q_{L}°÷240=0.6743×10¹⁸÷240=2.8×10¹⁵.

### The Starting Method of the Motor

Since b=b1=160 μm, it does not meet the starting condition and large mass charged particles need to be injected. Al₂O₃ is selected as the large mass charged particles for starting the motor to drive deuterium ions.

According to the minimum speed V₀ of the effective condition of deuterium ion, M=b×2eB÷(πV₀),

b=b1=160 μm, Lₐ=0.3 m,

M=m₄=6.4×10⁻²⁷ kg/particle,

V₀=b×2eB÷(πm₄)=160×10⁻⁶×2×1.6×10⁻¹⁹×0.02÷(3.14×6.4×10²⁷)=51 m/s,
The minimum speed V₀° of the charged particles meets the formula Lₐ=(b+V₀) V₀°,

V₀=Lₐ÷(b÷V₀)=0.3(160×10⁻⁶÷51)=96×10³ m/s,
the motor is started according to the starting condition of Al₂O₃, and when the speed of the charged particles reaches 96×10³ m/s,
the motor is started again according to the starting condition of deuterium ions, that is, the speed of the rotor is 51 m/s at startup. Then, the charged particles (Al₂O₃) are exported.
   (3) Deuterium and Tritium Accelerator with Speed of 1200 km/s

Since the speed of deuterium and tritium is only 1200 km/s, nanoparticles can be used to accelerate and drive neutral gas (deuterium and tritium) to reach 1200 km/s, that is, a DC energy storage accelerator similar to the DC energy storage accelerator in the previous electric aircrafts is used.

### 1) Main Parameters and Dimensions of Speed Motor

P_{N}=30000 kw, n_{N}=6000 r/min, P_{N}÷n_{N}=30000÷6000=5, Dₐ=100 cm, B=1.6 Wb/m², wherein P_{N} represents the power of the motor, n_{N} represents the rotating speed of the motor, B represents magnetic flux density,
2p=4,
Z÷(2p)=24, Z=24×4=96, Lₐ=50 cm, wherein Lₐ represents the length of the armature,

Vₐ=πDₐ×n÷60=3.14×1×6000÷60=314 m/s,

τ=πDₐ÷(2p)=3.14×100÷4=78.5 cm,

the pitch ta=πDₐ÷Z=3.14×100÷96=3.27 cm

According to the effective condition for starting energy storage: Lₐ°=(πb)÷4, when b=τ=78.5 cm,
Lₐ°=(3.14×78.5)÷4=61 cm>Lₐ=50 cm, which meets the effective condition for starting energy storage.

bs=ta÷2=3.27÷2=1.635 cm, wherein bs represents the width of the inner wall of the hollow tubes.

hs=bs=1.635 cm

eₐᵥ=2pφn÷60=2pBτLₐ×n÷60=4×1.6×0.785×0.5×6000÷60=251.2(v)

Assuming that the radius R of the energy storage ring is 5 m, and the total length L of the energy storage ring is 36 m.

The structure, material, and separation of the hollow tubes of the energy storage ring are the same as those of the electric aircrafts

u=Q_{R}÷(4πε₀r), u=251.2(v), r=40÷2=20 μm,

Q_{R}=4πε₀r×u=4π×1÷(36π)×10⁻⁹×20×10⁻⁶×251.2=558.2×10⁻¹⁵ C,

ρ₀=Q_{R}÷V₄, V₄=40×40×40 μm³,

ρ₀=558.2×10⁻¹⁵÷(40×10⁻³)³=8.722×10⁻⁹ C/mm³,
ρ₀ represents the density of the charge particles,
Vₛ=hs×(bs÷2)×L×Z=16.35×(16.35÷2)×36×10³×96=462×10⁶ mm³ wherein Vₛ represents the volume of gas in the energy storage hollow tubes.

Q_{L}=Vₛ×ρ₀=462×10⁶×8.722×10^{-9=4.029} C, wherein Q_{L} represents the amount of charges in the energy storage ring.

The charged particles in the energy storage ring are accelerated to 1200 km/s, and the circumference of the energy storage ring is 36 m.

The frequency f=1200×10³÷36=33.33×10³ cycles per second,
The current I in the energy storage ring is given by: I=Q_{L}f=4.029×33.33×0³=134×10³ A,
A°=I÷(πDₐ)=134×10³÷(3.14×100)=427.6 A/cm, which meets the requirements, wherein A° represents the linear charge of the motor.

W=lu=134×10³×251.2=33.66×10⁶ W=33.66 MW, wherein W represents the power of the motor.

### 2) Selection of Charged Particles and Neutral Gases, and Energy Storage Mass and Time

According to the effective acceleration condition of the charged particles: 1÷(12f)=π m (6eB)≥b÷V,

m=b×6eB÷(πV), when b=τ, V=Vₐ,

m=0.785×6×1.6×10⁻¹⁹÷(3.14×314)=7.64×10⁻²² kg.

Al₂O₃ nanomaterials are used as the charged particles, the neutral gas is deuterium and tritium, the mass m₃ of Al₂O₃ nanomaterials is 4×10⁻²¹ kg, which is greater than m₀=7.64×10⁻²² kg.

R′=m₃Vₐ÷(eB)=4×10⁻²¹×314÷(1.6×10⁻¹⁹×1.6)=4.9 m,

A=V²÷R′=314²÷4.9=20.1×10³ m/s²=20 km/s²,
Lₐ=0.5 m, L′=36 m, wherein Lₐ represents the length of the rotor, L′ represents the total length of the energy storage ring.

L=Lₐ=36÷0.5=72 (times), that is, the energy storage ring is accelerated for 72 seconds to make the charged particles in the energy storage ring to be accelerated to 20 km/s. If the charged particles are accelerated to 1200 km/s, the time t required is 4320 seconds, i.e., t=1200÷20×72=4320 s.

Q_{L}=4.029 0, wherein Q_{L} represents the amount of charges in the energy storage ring.

The number of charged particles in the energy storage ring is given by: Q_{L}°=Q_{L}×Q₀, a charge Q₀ of 1C is equivalent to the charge carried by 6.25×10¹⁸ protons, i.e. Q₀=6.25×10¹⁸ electrons,
Q_{L}°=4.029×6.25×10¹8=25.18×10¹⁸ C,
m=Q_{L}°m₃=25.18×10¹⁸×4×10⁻²¹ kg=0.1 kg, wherein m represents the mass of the charged particles in the energy storage ring.

When the energy storage ring is accelerated for 4320 seconds, 0.1 kg of the charged particles can be accelerated to 1200 km/s.

Assuming that the energy storage ring is accelerated for 10 hours, then t°÷t=10×3600÷4320=8.3 times.

It can make 0.73 kg of deuterium to be accelerated to 1200 km/s, wherein 0.73 kg=0.1 kg×(8.3−1).

If 0.73 kg of deuterium is output in 24 hours,
the mass mₛ of the deuterium output per second is 8.44×10⁻⁶ kg, i.e., mₛ=0.73 kg÷(24×3600)=8.44×10⁻⁶ kg.

The molecular weight of deuterium is 4, M_{H}=4m₀=4×1.6×10⁻²⁷=6.4×10⁻²⁷ kg/particle, wherein M_{H} represents the mass of deuterium.

M_{S}=mₛ÷M_{H}=8.44×10⁻⁶ kg÷(6.4×10⁻²⁷) kg/particle=1.3×10²¹ particles, wherein M_{S} represents the number of deuterium output per second.

The fusion reaction meets the condition of nτ≥10¹⁴-10¹⁶ S/cm³.

According to the above calculation, the number of deuterium output per second (M_{S}=1.3×10²¹ particles) is far greater than the above requirements.

According to the effective condition for starting energy storage: Lₐ°=(πb)÷4, when b=τ=78.5 cm,
Lₐ°=61 cm>Lₐ=50 cm, which meets the starting condition.

According to M=b×2eB÷(πV₀), M=M₃=4×10⁻²¹ (kg/particle),

V₀=b×2eB÷(πM₃)=0.785×2×1.6×10⁻¹⁹×1.6÷(3.14×4×10⁻²¹)

V₀=32 m/s, that is, the circumferential speed of the rotor of the motor is 32 m/s when starting.

If eight energy storage motors are used, four energy storage motors are running and four energy storage motors are standby; they are each charged for 10-hour for storing energy, so it is no problem to use them alternately every day.

According to the number of deuterium output per second (M_{S}=1.3×10²¹ particles), 0.73 kg of deuterium is output in 24 hours a day.

Four energy storage motors are running, the mass of deuterium output in 24 hours a day is 4×0.73 kg=2.92 kg.

The energy provided by one gram of deuterium is equivalent to that of 11 tons of coal, then the energy provided by 2.92 kg of deuterium is equivalent to the energy provided by 2.92×10³×11=32.12×10³ tons of coal=32.12×10³×10³ kilograms of coal, each kilogram of coal can generate 3 kWh of electricity.

Electricity generated in a day is 32.12×10³×10³×3=96.36×10⁶ kWh.

The installed capacity of the generator is 96.36×10⁶ kWh÷24=4×10⁶ kW=4000 MW.

### (4) Discussion on Nuclear Fusion Method and Structure

It is envisaged to use a vacuum spherical body and eight symmetrically accelerated deuterium and tritium accelerators with a speed of 1200 km/s are placed on a horizontal plane. Four deuterium and tritium gases collide and operate, and four are standby. Since deuterium and tritium are accelerated by charged particle collisions and deuterium and tritium themselves are not charged, the collision will not produce Coulomb repulsion, which can keep the deuterium and tritium fuel continuously at around 100 million Celsius, and the density is far greater than required.

On the vertical plane of the ball, four deuterium and tritium accelerators with a speed of 70% the speed of light are arranged, two are operating for ignition, and two are standby. A large number of water-cooled tubes are arranged on the surface of the ball to generate steam for power generation.

According to the above calculation, controlled nuclear fusion reaction with an installed capacity of 4 million KW.

Main Symbol Table

| No. | symbol | Name | No. | symbol | Name |
|---|---|---|---|---|---|
| 1 | A | electric load (or line load) | 26 | P_{y} | afterburner |
| 2 | a | acceleration | 27 | P₂₀ | 20 atmospheres |
| 3 | B | flux density | 28 | Q_{R} | the amount of charges |
| | | | | | enclosed by a hollow sphere |
| | | | | | of radius r |
| 4 | b | circumferential length of | 29 | Q₀ | 1 C (the charge carried by |
| | | the rotor | | | 6.25 × 10¹⁸ protons) |
| 5 | bs | width of the inner wall of | 30 | Q_{L} | The total number of charges |
| | | the hollow tube | | | in the energy storage ring |
| 6 | Dₐ | outer diameter of the | 31 | R | radius |
| | | armature | | | |
| 7 | Dj | outer diameter of the base | 32 | Sₘ | surface area |
| 8 | e | charge of the rotor | 33 | V | speed |
| 9 | eₐᵥ | average induced electromotive force | 34 | Vₛ | volume of gas in the energy |
| | | of rotor hollow tubes | | | storage ring |
| 10 | Eₐ | Induced electromotive | 35 | V₄ | 40 × 40 × 40 μm³ |
| | | force of an armature | | | |
| | | winding | | | |
| 11 | F | force | 36 | W | energy |
| 12 | f | frequency | 37 | W′ | Calorific value per liter of |
| | | | | | gasoline |
| 13 | hs | height of the inner wall of | 38 | W₀ | electrical energy per kWh (J) |
| | | the hollow tube | | | |
| 14 | I | current | 39 | Z | number of slots |
| 15 | Lₐ | length of the rotor | 40 | ρ_{N} | density of nickel |
| 16 | n_{N} | rated rotational speed | 41 | ρ_{F} | density of iron |
| 17 | nₘ | moles of gas | 42 | ρ_{y} | density of mica |
| 18 | ms | mass of deuterium output | 43 | ρ_{P} | density of the glass |
| | | per second | | | |
| 19 | mₛ | the number of deuterium | 44 | τ | polar distance |
| | | output per second | | | |
| 20 | mₖ | mass of K⁺ | 45 | φ | magnetic flux per pole |
| 21 | m₃ | mass of Al₂O₃ | 46 | _{ε0} | vacuum permittivity |
| 22 | m₆ | mass of SF₆ | 47 | | |
| 23 | m | mass | 48 | | |
| 24 | p | the number of pairs of | 49 | | |
| | | magnetic poles | | | |
| 25 | P_{N} | rated power | | | |

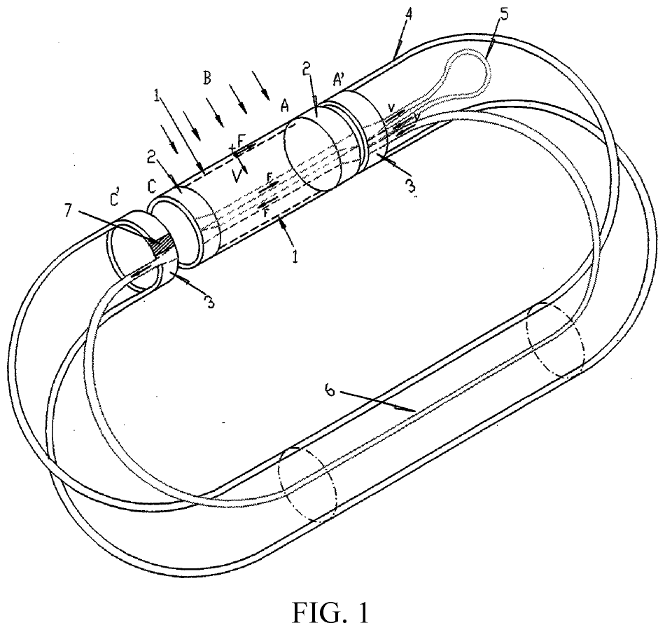

1. A direct-current (DC) motor, comprising an accelerator and an energy storage ring, wherein a rotor of the DC motor comprises Z slots embedded with Z rotor hollow tubes, wherein Z is an integer, wherein a first end of the Z rotor hollow tubes is connected to a first rotor commutation ring, and a second end of the Z rotor hollow tubes is connected to a second rotor commutation ring, the Z rotor hollow tubes, the first rotor commutation ring, and the second rotor commutation ring constitute a rotor hollow tube winding, a first fixed commutation ring is installed on a first side of the first rotor commutation ring away from the Z rotor hollow tubes, and a second fixed commutation ring is installed on a second side of the second rotor commutation ring away from the Z rotor hollow tubes, wherein a gap is provided between the first fixed commutation ring and the first rotor commutation ring, and a gap is provided between the second fixed commutation ring and the second rotor commutation ring, the first fixed commutation ring communicates with the second fixed commutation ring through Z fixed hollow tubes, the Z rotor hollow tubes and the Z fixed hollow tubes constitute the energy storage ring, fixed commutation hollow tube groups are connected at a junction of two main magnetic poles (as shown in FIG. 1).

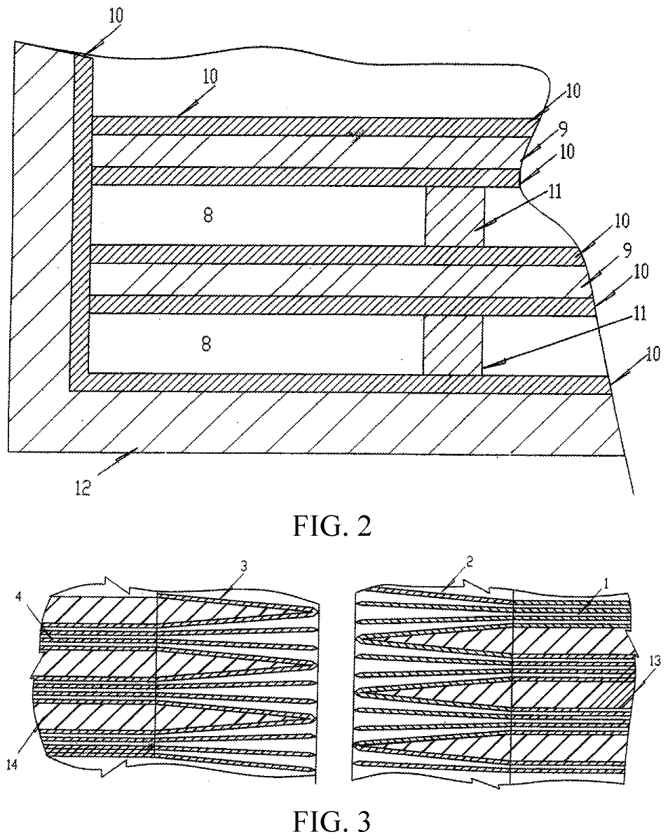

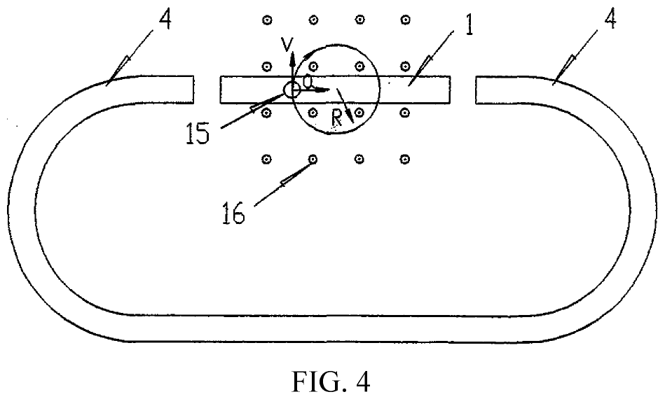

2. The DC motor according to claim 1, wherein each hollow tube in the energy storage ring is divided into a plurality of thin-film cavities made of ultra-thin materials (i.e., a thin-film partition layer, e.g., ultra-thin glass with a thickness on the order of microns), wherein a width of an inner wall of each thin-film cavity is in the order of micrometers, millimeters, or nanometers, and a height of the inner wall of each thin-film cavity is in the order of millimeters, micrometers, or nanometers, wherein a micro-scale conductive coating layer ((i.e., micron-level conductive coating layer, e.g., a chemical nickel coating layer) is continuously or intermittently plated on an inner wall of each hollow tube and the inner wall of each thin-film cavity (i.e., positive and negative electrodes coexist), wherein the thin-film cavities are partially or entirely made of ultra-thin purely conductive materials (i.e., a pure conductive partition layer), so that electricity can be conducted between adjacent thin-film cavities in the hollow tubes (i.e., positive and negative electrodes coexist) (as shown in FIG. 2).

3. The DC motor according to claim 1, wherein as the thin-film cavities extends into the rotor commutation rings and the fixed commutation rings, a height of the thin-film cavities remains unchanged, and a width of the thin-film cavities gradually increases, wherein the thin-film cavities of equal height and width are evenly distributed at an end of the rotor commutation rings and the fixed commutation rings, wherein as the thin-film cavities extend closer to the end of the commutation rings, walls of the thin-film cavities gradually thin, and as the thin-film cavities reach the end of the commutation rings, the thickness of the walls is close to zero, wherein the thin-film cavities at the end of the commutation rings generates corona at a low voltage, so that high-speed moving neutral gas mediums closing to the end of the commutation rings are positively charged and the neutral gas mediums are prevented from hitting the commutation rings due to coulomb repulsion (as shown in FIG. 3).

4. The DC motor according to claim 1, wherein the fixed commutation hollow tubes are installed at a junction of two opposite magnetic poles, and charged particles and neutral gases in the rotor hollow tubes are introduced into another hollow tube whose direction of motion is the same as the direction of motion of the charged particles through the fixed commutation hollow tubes before changing its direction of motion; wherein an input end, which is for inputting the charged particles, of a fixed hollow tube corresponding to the rotor hollow tube whose charged particles have been exported is closed without connecting a hollow tube; wherein charged particles moving in the opposite direction to original charged particles can be introduced into an empty rotor hollow tube through a fixed commutation hollow tube (as shown in FIG. 1) or charged particles moving in the same direction to the original charged particles can be introduced into an empty rotor hollow tube through a fixed commutation hollow tube, wherein P pairs of magnetic poles correspond to 2P fixed commutation hollow tube group, wherein P is an integer.

5. The DC motor according to claim 2, wherein charged particles with the same polarity are injected into each thin-film cavity of the energy storage ring.

6. The DC motor according to claim 5, wherein in each thin-film cavity of the energy storage ring, a large amount of energy needs to be stored, the charged particles and neutral gas mediums (gas mediums which tend not to generate charged particles after collision) (such as, pure argon gas) are injected into each thin-film cavity.

7. The DC motor according to claim 2, wherein in each thin-film cavity of the energy storage ring, the inner wall of each thin-film cavity has a DC voltage with the same polarity as the charged particles (or positive and negative electrodes coexist).

8. The DC motor according to claim 2, wherein a voltage of the charged particles in each thin-film cavity of the energy storage ring is given by: u=Q_{R}÷(4πε₀r)=r²ρ÷(3ε₀),
wherein u represents the voltage of the charged particles in each thin-film cavity,
Q_{R} represents a total amount of charges surrounded by a thin-film cavity with a sphere radius of r,
ε₀ represents the vacuum permittivity,
r represents a minimum distance from a center of a thin-film cavity to an inner wall of the thin-film cavity,
ρ represents a density of the charged particles,
wherein U=Eₐ=eₐᵥ=2pφn÷60=r²ρ÷(3ε₀),
wherein eₐᵥ represents an average induced electromotive force of a rotor conductor (unit: V), Eₐ represents an electromotive force of an armature (unit: V), p represents the number of pairs of magnetic poles,
φ represents a magnetic flux per pole (unit: Wb), n represents the number of revolutions per minute of the armature.

9. The DC motor according to claim 2, wherein an effective condition for storing energy in each thin-film cavity of the energy storage ring is 1÷(4f)=πm÷(2eB)≥b÷V,
wherein f represents a frequency (unit: circumferences per second).
m represents a mass of a particle (unit: kg),
e represents a charge of the particle (unit: C),
B represents a magnetic flux density (unit: Wb/m²),
V represents a speed of the particle (unit: m/s),
wherein b has three potential values: b1 is 2 times a width of a thin-film cavity; b2 is a pitch,
and b3 is a polar distance.

10. The DC motor according to claim 2, wherein in each thin-film cavity of the energy storage ring, an effective condition for starting energy storage is given by: Lₐ≤eBb²÷(2 mVₐ),
wherein Lₐ represents a length of the rotor (unit: m),
b represents a width that meets an effective condition for storing energy (unit: m),
m represents a mass of charged particles satisfying the effective condition for storing energy (unit: kg),
Vₐ represents a circular speed of the rotor (unit: m/s).

11. The DC motor according to claim 10, wherein the effective condition for starting energy storage requires that a size of the DC motor satisfies a formula Lₐ≤(πb)÷4 and that when starting, a rotating speed of the DC motor is reduced to meet a formula V₀=b×2eB÷(πM),
wherein M represents the mass of the charged particles in the hollow tubes (unit: kg),
V₀ represents a starting speed of the rotor when it makes a circular motion (unit: m/s),
b represents a width that meets the effective condition for storing energy (unit: m).

12. The DC motor according to claim 11, wherein an improvement measure for storing energy is: when the mass of the charged particles does not meet the effective condition for storing energy, the charged particles with large mass that meet the effective condition are injected to drive the charged particles with small mass, when a certain speed is reached, i.e., Lₐ=V_{d}Δt=V_{d}(b÷Vₐ), the charged particles with small mass are left in the energy storage ring and the charged particles with large mass are derived from the energy storage ring by means of magnetic confinement, that is, the acceleration of charged particles with small mass are initiated,
wherein V_{d} represents a speed of the charged particles in the energy storage ring,
Vₐ represents a starting speed of the rotor with small-mass when it makes a circular motion (unit: m/s).

13. The DC motor according to claim 7, wherein the inner wall of each thin-film cavity has the DC voltage of the same polarity as the charged particles (or positive and negative electrodes coexist), so that the charged particles overcome their own weight and are suspended in each thin-film cavity, and suspended charged particles are restrained, keeping them away from the inner wall of the thin-film cavities and reducing a friction loss of high-speed moving charged particles on the inner wall of the thin-film cavities.

14. The DC motor according to claim 5, wherein when charged particles moves forward at a high speed, a local low vacuum is formed behind the charged particles to enable neutral gases to be confined behind the charged particles, and a negative pressure is also formed in an air gap between a rotor commutation ring and a corresponding fixed commutation ring to enable the inside of the motor to remain vacuum and prevent gases from leaking from the thin-film cavities.

15. The DC motor according to claim 5, wherein the charged particles with the same polarity fill entire closed thin-film cavities, when a charged particle accelerates, other charged particles will also move due to synchronous repulsion, thereby accelerating the charged particles as a whole in the thin-film cavities for energy storage.

16. The DC motor according to claim 9, wherein for each thin-film cavity of the energy storage ring, corresponding parameters are selected to meet a formula R=mV÷(eB), and high-speed moving charged particles stably operate in the closed energy storage ring using magnetic confinement.

17. (canceled)

18. (canceled)

19. (canceled)

20. The DC motor according to claim 9, wherein high-speed moving charged particles are cooled in each hollow tube of the energy storage ring by cooling fixed hollow tubes, thereby cooling the energy storage ring and an iron core of the rotor.

21. The DC motor according to claim 1, wherein there are two methods to provide kinetic energy for the accelerator and the energy storage ring of the DC motor, a first method is to use a prime mover including but not limited to an external DC motor rotating at high speed to drive the energy storage DC motor through mechanical components, and a second method is to integrate an external DC motor and an energy storage DC motor together to form a unibody design, so that the external direct current will drive both the external DC motor and the energy storage DC motor, thereby storing energy.

22. (canceled)

23. The DC motor according to claim 21, wherein the external DC motor and the energy storage DC motor are integrated together to form the accelerator and the energy storage ring of the DC motor, wherein an armature winding of the external DC motor is connected to a controllable switch.

24. The DC motor according to claim 1, wherein a method for regulating a rotating speed of the accelerator and the energy storage ring of the DC motor comprises: 1) regulating the rotating speed of the accelerator and the energy storage ring using magnetic field weakening, wherein the rotating speed of the accelerator and the energy storage ring is regulated upward from a rated speed; 2) regulating the rotating speed of the accelerator and the energy storage ring by reducing a voltage of the charged particles in the thin-film cavities of the rotor: indirectly reducing the voltage of the charged particles of the thin-film cavities of the rotor by reducing a voltage of an inner wall of the thin-film cavities of the rotor hollow tubes and a voltage of an inner wall of the thin-film cavities of the fixed hollow tubes, wherein the lower the voltage of the charged particles is, the lower the rotating speed of the accelerator and the energy storage ring is, wherein the rotating speed of the accelerator and the energy storage ring is regulated downward from the rated speed.

25. The DC motor according to claim 23, wherein when a DC energy storage machine is used as the DC motor, the controllable switch that connected to an armature winding of a DC motor of an external prime mover is closed for a short time, if a direction of a torque generated by the DC motor of the external prime mover is opposite to that of a torque generated by the DC energy storage machine, a rotating speed of the DC energy storage machine is decreased, and if a short-circuit current value of a rotor of an external DC motor is too large, a resistor is connected in series with the rotor of the external DC motor.

26. The DC motor according to claim 8, wherein a voltage of the charged particles in each thin-film cavity of the energy storage ring is given by: u=Q_{R}÷(4πε₀r)=r²ρ÷(3ε₀), a total charge of the charged particles in the energy storage ring is given by: Q_{L}=Vₛ×ρ₀,
wherein Vₛ represents a total volume of gases in the hollow tubes in the energy storage ring, ρ=ρ₀,
I represents a current value of the rotor, I=Q_{L}f,
wherein f represents a frequency of the charged particles and gases in the energy storage ring, f=V÷L,
wherein V represents an energy storage speed of the charged particles and the gases in the energy storage ring,
L represents a circumference of the energy storage ring.

27. The DC motor according to claim 9, wherein the effective condition for storing energy is 1÷(4f)=πm÷(2eB)≥b÷V, different masses of charged particles are obtained based on different values of b, and when a value of b ranges from the polar distance to the width of the thin-film hollow tubes, the charged particles are selected from nanomaterials, molecules, and atoms.

28. The DC motor according to claim 27, wherein the charged particles are selected from aluminum trioxide (Al₂O₃) nanomaterials, or ions including gold ions, potassium ions, and deuterium ions.

29. The DC motor according to claim 6, wherein when each hollow tube of the energy storage ring needs to store a large amount of energy, sulfur hexafluoride (SF6) gases are injected into each thin-film cavity.

30. The DC motor according to claim 6, wherein the charged particles and the neutral gas mediums are injected into each thin-film cavity of the energy storage ring, when an energy storage speed of injected charged particles and neutral gases (e.g., deuterium gases and tritium gases) reaches 1200 km/s, a temperature value of the neutral gases reaches 100 million Celsius after collision, which meets a condition for maintaining a controllable fusion reaction, and the released energy is more than 400 times the input energy.
